(19) United States
(12) Patent Application Publication
(10) Pub. No.: US 2025/0184985 A1
(43) Pub. Date: Jun. 5, 2025

(54) APPARATUS, SYSTEM, AND METHOD OF COMMUNICATING A MILLIMETERWAVE (MMWAVE) PHYSICAL LAYER (PHY) PROTOCOL DATA UNIT (PPDU) ACCORDING TO AN MMWAVE CHANNELIZATION SCHEME

(71) Applicant: INTEL CORPORATION, SANTA CLARA, CA (US)

(72) Inventors: Po-Kai Huang, San Jose, CA (US); Carlos Cordeiro, Portland, OR (US); Laurent Cariou, Milizac (FR); Cheng Chen, Camas, WA (US)

(73) Assignee: INTEL CORPORATION, SANTA CLARA, CA (US)

(21) Appl. No.: 18/842,843

(22) PCT Filed: Mar. 31, 2022
(86) PCT No.: PCT/US2022/022907

§ 371 Date: Aug. 30, 2024

(51) Int. Cl. H04W 72/0457

(52) U.S. Cl. CPC H04W 72/0457

(57) ABSTRACT

For example, a wireless communication device may be configured to generate a millimeter Wave (mmWave) Physical layer (PHY) Protocol Data Unit (PPDU) configured for transmission over an mmWave wireless communication channel according to an mmWave channelization scheme, the mm Wave channelization scheme defining a plurality of mmWave channels in an mmWave wireless communication frequency band, wherein the plurality of mmWave channels are based on a minimal mm Wave channel bandwidth (BW), wherein the minimal mm Wave channel BW is equal to or greater than 80 Megahertz (MHz) and not more than 640 MHZ; and to transmit the mmWave PPDU over the mm Wave wireless communication channel.

### TECHNICAL FIELD

Aspects described herein generally relate to communicating a millimeterWave (mmWave) Physical layer (PHY) Protocol Data Unit (PPDU) according to an mmWave channelization scheme.

### BACKGROUND

Devices in a wireless communication system may be configured to communicate over a millimeterWave (mmWave) wireless communication channel.

For example, the device in the wireless communication system may be configured communicate according to a channelization scheme including channels of a minimum bandwidth of 2.16 Gigahertz (GHz). The channelization scheme may also include wide channels of 4.32 GHz, 6.48 GHz, and/or 8.64 GHz bandwidths.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below.

FIG. 1 is a schematic block diagram illustration of a system, in accordance with some demonstrative aspects.

FIG. 2 is a schematic illustration of a multi-link communication scheme, which may be implemented in accordance with some demonstrative aspects.

FIG. 3 is a schematic illustration of a multi-link communication scheme, which may be implemented in accordance with some demonstrative aspects.

FIG. 4 is a schematic illustration of millimeterWave (mmWave) channels according to a mmWave channelization scheme, in accordance with some demonstrative aspects.

FIG. 5 is a schematic flow-chart illustration of a method of communicating an mmWave Physical layer (PHY) Protocol Data Unit (PPDU) according to an mmWave channelization scheme, in accordance with some demonstrative aspects.

FIG. 6 is a schematic illustration of a product of manufacture, in accordance with some demonstrative aspects.

### DETAILED DESCRIPTION

In the following detailed description, numerous specific details are set forth in order to provide a thorough understanding of some aspects. However, it will be understood by persons of ordinary skill in the art that some aspects may be practiced without these specific details. In other instances, well-known methods, procedures, components, units and/or circuits have not been described in detail so as not to obscure the discussion.

Discussions herein utilizing terms such as, for example, “processing”, “computing”, “calculating”, “determining”, “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

The terms “plurality” and “a plurality”, as used herein, include, for example, “multiple” or “two or more”. For example, “a plurality of items” includes two or more items.

References to “one aspect”, “an aspect”, “demonstrative aspect”, “various aspects” etc., indicate that the aspect(s) so described may include a particular feature, structure, or characteristic, but not every aspect necessarily includes the particular feature, structure, or characteristic. Further, repeated use of the phrase “in one aspect” does not necessarily refer to the same aspect, although it may.

As used herein, unless otherwise specified the use of the ordinal adjectives “first”, “second”, “third” etc., to describe a common object, merely indicate that different instances of like objects are being referred to, and are not intended to imply that the objects so described must be in a given sequence, either temporally, spatially, in ranking, or in any other manner.

Some aspects may be used in conjunction with various devices and systems, for example, a User Equipment (UE), a Mobile Device (MD), a wireless station (STA), a Personal Computer (PC), a desktop computer, a mobile computer, a laptop computer, a notebook computer, a tablet computer, a server computer, a handheld computer, a handheld device, a wearable device, a sensor device, an Internet of Things (IoT) device, a Personal Digital Assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless Access Point (AP), a wired or wireless router, a wired or wireless modem, a video device, an audio device, an audio-video (A/V) device, a wired or wireless network, a wireless area network, a Wireless Video Area Network (WVAN), a Local Area Network (LAN), a Wireless LAN (WLAN), a Personal Area Network (PAN), a Wireless PAN (WPAN), and the like.

Some aspects may be used in conjunction with devices and/or networks operating in accordance with existing IEEE 802.11 standards (including IEEE 802.11-2020 (IEEE 802.11-2020, IEEE Standard for Information Technology—Telecommunications and Information Exchange between Systems Local and Metropolitan Area Networks—Specific Requirements; Part 11: Wireless LAN Medium Access Control (MAC) and Physical Layer (PHY) Specifications, December 2020); and/or IEEE 802.11be (IEEE P802.11be/D1.4 Draft Standard for Information technology—Telecommunications and information exchange between systems Local and metropolitan area networks—Specific requirements; Part 11: Wireless LAN Medium Access Control (MAC) and Physical Layer (PHY) Specifications; Amendment 8: Enhancements for extremely high throughput (EHT), January 2022)) and/or future versions and/or derivatives thereof, devices and/or networks operating in accordance with existing cellular specifications and/or protocols, e.g., 3rd Generation Partnership Project (3GPP), 3GPP Long Term Evolution (LTE) and/or future versions and/or derivatives thereof, units and/or devices which are part of the above networks, and the like.

Some aspects may be used in conjunction with one way and/or two-way radio communication systems, cellular radio-telephone communication systems, a mobile phone, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device, e.g., a Smartphone, a Wireless Application Protocol (WAP) device, or the like.

Some aspects may be used in conjunction with one or more types of wireless communication signals and/or systems, for example, Radio Frequency (RF), Infra-Red (IR), Frequency-Division Multiplexing (FDM), Orthogonal FDM (OFDM), Orthogonal Frequency-Division Multiple Access (OFDMA), FDM Time-Division Multiplexing (TDM), Time-Division Multiple Access (TDMA), Multi-User MIMO (MU-MIMO), Spatial Division Multiple Access (SDMA), Extended TDMA (E-TDMA), General Packet Radio Service (GPRS), extended GPRS, Code-Division Multiple Access (CDMA), Wideband CDMA (WCDMA), CDMA 2000, single-carrier CDMA, multi-carrier CDMA, Multi-Carrier Modulation (MDM), Discrete Multi-Tone (DMT), Bluetooth®, Global Positioning System (GPS), Wi-Fi, Wi-Max, ZigBee™, Ultra-Wideband (UWB), Global System for Mobile communication (GSM), 2G, 2.5G, 3G, 3.5G, 4G, Fifth Generation (5G), or Sixth Generation (6G) mobile networks, 3GPP, Long Term Evolution (LTE), LTE advanced, Enhanced Data rates for GSM Evolution (EDGE), or the like. Other aspects may be used in various other devices, systems and/or networks.

The term “wireless device”, as used herein, includes, for example, a device capable of wireless communication, a communication device capable of wireless communication, a communication station capable of wireless communication, a portable or non-portable device capable of wireless communication, or the like. In some demonstrative aspects, a wireless device may be or may include a peripheral that may be integrated with a computer, or a peripheral that may be attached to a computer. In some demonstrative aspects, the term “wireless device” may optionally include a wireless service.

The term “communicating” as used herein with respect to a communication signal includes transmitting the communication signal and/or receiving the communication signal. For example, a communication unit, which is capable of communicating a communication signal, may include a transmitter to transmit the communication signal to at least one other communication unit, and/or a communication receiver to receive the communication signal from at least one other communication unit. The verb communicating may be used to refer to the action of transmitting or the action of receiving. In one example, the phrase “communicating a signal” may refer to the action of transmitting the signal by a first device, and may not necessarily include the action of receiving the signal by a second device. In another example, the phrase “communicating a signal” may refer to the action of receiving the signal by a first device, and may not necessarily include the action of transmitting the signal by a second device. The communication signal may be transmitted and/or received, for example, in the form of Radio Frequency (RF) communication signals, and/or any other type of signal.

As used herein, the term “circuitry” may refer to, be part of, or include, an Application Specific Integrated Circuit (ASIC), an integrated circuit, an electronic circuit, a processor (shared, dedicated or group), and/or memory (shared. Dedicated, or group), that execute one or more software or firmware programs, a combinational logic circuit, and/or other suitable hardware components that provide the described functionality. In some aspects, the circuitry may be implemented in, or functions associated with the circuitry may be implemented by, one or more software or firmware modules. In some aspects, circuitry may include logic, at least partially operable in hardware.

The term “logic” may refer, for example, to computing logic embedded in circuitry of a computing apparatus and/or computing logic stored in a memory of a computing apparatus. For example, the logic may be accessible by a processor of the computing apparatus to execute the computing logic to perform computing functions and/or operations. In one example, logic may be embedded in various types of memory and/or firmware, e.g., silicon blocks of various chips and/or processors. Logic may be included in, and/or implemented as part of, various circuitry, e.g. radio circuitry, receiver circuitry, control circuitry, transmitter circuitry, transceiver circuitry, processor circuitry, and/or the like. In one example, logic may be embedded in volatile memory and/or non-volatile memory, including random access memory, read only memory, programmable memory, magnetic memory, flash memory, persistent memory, and the like. Logic may be executed by one or more processors using memory, e.g., registers, stuck, buffers, and/or the like, coupled to the one or more processors, e.g., as necessary to execute the logic.

Some demonstrative aspects may be used in conjunction with a WLAN, e.g., a WiFi network. Other aspects may be used in conjunction with any other suitable wireless communication network, for example, a wireless area network, a “piconet”, a WPAN, a WVAN and the like.

Some demonstrative aspects may be used in conjunction with a wireless communication network communicating over a sub-10 Gigahertz (GHz) frequency band, for example, a 2.4 GHz frequency band, a 5 GHz frequency band, a 6 GHz frequency band, and/or any other frequency band below 10 GHz.

Some demonstrative aspects may be used in conjunction with a wireless communication network communicating over an Extremely High Frequency (EHF) band (also referred to as the “millimeter wave (mmWave)” frequency band), for example, a frequency band within the frequency band of between 20 Ghz and 300 GHz, for example, a frequency band above 45 GHz, e.g., a 60 GHz frequency band, and/or any other mmWave frequency band.

Some demonstrative aspects may be used in conjunction with a wireless communication network communicating over the sub-10 GHz frequency band and/or the mmWave frequency band, e.g., as described below. However, other aspects may be implemented utilizing any other suitable wireless communication frequency bands, for example, a 5G frequency band, a frequency band below 20 GHz, a Sub 1 GHz (S1G) band, a WLAN frequency band, a WPAN frequency band, and the like.

Some demonstrative aspects may be implemented by a mmWave STA (mSTA), which may include for example, a STA having a radio transmitter, which is capable of operating on a channel that is within the mmWave frequency band. In one example, mmWave communications may involve one or more directional links to communicate at a rate of multiple gigabits per second, for example, at least 1 Gigabit per second, e.g., at least 7 Gigabit per second, at least 30 Gigabit per second, or any other rate.

In some demonstrative aspects, the mmWave STA may include a Directional Multi-Gigabit (DMG) STA, which may be configured to communicate over a DMG frequency band. For example, the DMG band may include a frequency band wherein the channel starting frequency is above 45 GHz.

In some demonstrative aspects, the mmWave STA may include an Enhanced DMG (EDMG) STA, which may be configured to implement one or more mechanisms, which may be configured to enable Single User (SU) and/or Multi-User (MU) communication of Downlink (DL) and/or Uplink frames (UL) using a MIMO scheme. For example, the EDMG STA may be configured to implement one or more channel bonding mechanisms, which may, for example, support communication over a channel bandwidth (BW) (also referred to as a “wide channel”, an “EDMG channel”, or a “bonded channel”) including two or more channels, e.g., two or more 2.16 GHz channels. For example, the channel bonding mechanisms may include, for example, a mechanism and/or an operation whereby two or more channels, e.g., 2.16 GHz channels, can be combined, e.g., for a higher bandwidth of packet transmission, for example, to enable achieving higher data rates, e.g., when compared to transmissions over a single channel. Some demonstrative aspects are described herein with respect to communication over a channel BW including two or more 2.16 GHz channels, however other aspects may be implemented with respect to communications over a channel bandwidth, e.g., a “wide” channel, including or formed by any other number of two or more channels, for example, an aggregated channel including an aggregation of two or more channels. For example, the EDMG STA may be configured to implement one or more channel bonding mechanisms, which may, for example, support an increased channel bandwidth, for example, a channel BW of 4.32 GHz, a channel BW of 6.48 GHz, a channel BW of 8.64 GHz, and/or any other additional or alternative channel BW. The EDMG STA may perform other additional or alternative functionality.

In other aspects, the mmWave STA may include any other type of STA and/or may perform other additional or alternative functionality. Other aspects may be implemented by any other apparatus, device and/or station.

The term “antenna”, as used herein, may include any suitable configuration, structure and/or arrangement of one or more antenna elements, components, units, assemblies and/or arrays. In some aspects, the antenna may implement transmit and receive functionalities using separate transmit and receive antenna elements. In some aspects, the antenna may implement transmit and receive functionalities using common and/or integrated transmit/receive elements. The antenna may include, for example, a phased array antenna, a single element antenna, a set of switched beam antennas, and/or the like.

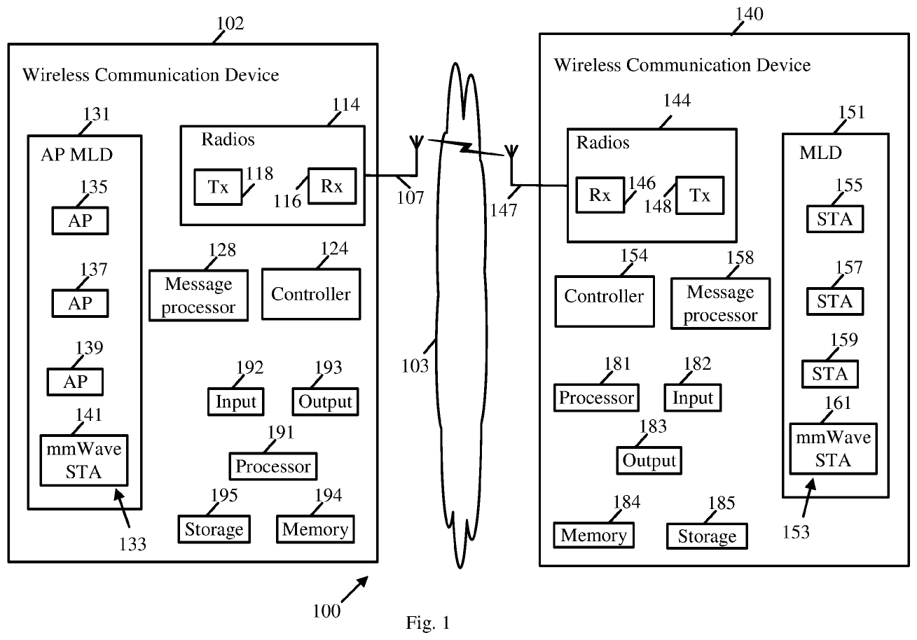

Reference is made to FIG. 1, which schematically illustrates a system 100, in accordance with some demonstrative aspects.

As shown in FIG. 1, in some demonstrative aspects, system 100 may include one or more wireless communication devices. For example, system 100 may include a wireless communication device 102, a wireless communication device 140, and/or one or more other devices.

In some demonstrative aspects, devices 102 and/or 140 may include a mobile device or a non-mobile, e.g., a static, device.

For example, devices 102 and/or 140 may include, for example, a UE, an MD, a STA, an AP, a PC, a desktop computer, a mobile computer, a laptop computer, an Ultrabook™ computer, a notebook computer, a tablet computer, a server computer, a handheld computer, an Internet of Things (IoT) device, a sensor device, a handheld device, a wearable device, a PDA device, a handheld PDA device, an on-board device, an off-board device, a hybrid device (e.g., combining cellular phone functionalities with PDA device functionalities), a consumer device, a vehicular device, a non-vehicular device, a mobile or portable device, a non-mobile or non-portable device, a mobile phone, a cellular telephone, a PCS device, a PDA device which incorporates a wireless communication device, a mobile or portable GPS device, a DVB device, a relatively small computing device, a non-desktop computer, a “Carry Small Live Large” (CSLL) device, an Ultra Mobile Device (UMD), an Ultra Mobile PC (UMPC), a Mobile Internet Device (MID), an “Origami” device or computing device, a device that supports Dynamically Composable Computing (DCC), a context-aware device, a video device, an audio device, an A/V device, a Set-Top-Box (STB), a Blu-ray disc (BD) player, a BD recorder, a Digital Video Disc (DVD) player, a High Definition (HD) DVD player, a DVD recorder, a HD DVD recorder, a Personal Video Recorder (PVR), a broadcast HD receiver, a video source, an audio source, a video sink, an audio sink, a stereo tuner, a broadcast radio receiver, a flat panel display, a Personal Media Player (PMP), a digital video camera (DVC), a digital audio player, a speaker, an audio receiver, an audio amplifier, a gaming device, a data source, a data sink, a Digital Still camera (DSC), a media player, a Smartphone, a television, a music player, or the like.

In some demonstrative aspects, device 102 may include, for example, one or more of a processor 191, an input unit 192, an output unit 193, a memory unit 194, and/or a storage unit 195; and/or device 140 may include, for example, one or more of a processor 181, an input unit 182, an output unit 183, a memory unit 184, and/or a storage unit 185. Devices 102 and/or 140 may optionally include other suitable hardware components and/or software components. In some demonstrative aspects, some or all of the components of one or more of devices 102 and/or 140 may be enclosed in a common housing or packaging, and may be interconnected or operably associated using one or more wired or wireless links. In other aspects, components of one or more of devices 102 and/or 140 may be distributed among multiple or separate devices.

In some demonstrative aspects, processor 191 and/or processor 181 may include, for example, a Central Processing Unit (CPU), a Digital Signal Processor (DSP), one or more processor cores, a single-core processor, a dual-core processor, a multiple-core processor, a microprocessor, a host processor, a controller, a plurality of processors or controllers, a chip, a microchip, one or more circuits, circuitry, a logic unit, an Integrated Circuit (IC), an Application-Specific IC (ASIC), or any other suitable multi-purpose or specific processor or controller. Processor 191 may execute instructions, for example, of an Operating System (OS) of device 102 and/or of one or more suitable applications. Processor 181 may execute instructions, for example, of an Operating System (OS) of device 140 and/or of one or more suitable applications.

In some demonstrative aspects, input unit 192 and/or input unit 182 may include, for example, a keyboard, a keypad, a mouse, a touch-screen, a touch-pad, a track-ball, a stylus, a microphone, or other suitable pointing device or input device. Output unit 193 and/or output unit 183 may include, for example, a monitor, a screen, a touch-screen, a flat panel display, a Light Emitting Diode (LED) display unit, a Liquid Crystal Display (LCD) display unit, a plasma display unit, one or more audio speakers or earphones, or other suitable output devices.

In some demonstrative aspects, memory unit 194 and/or memory unit 184 includes, for example, a Random Access Memory (RAM), a Read Only Memory (ROM), a Dynamic RAM (DRAM), a Synchronous DRAM (SD-RAM), a flash memory, a volatile memory, a non-volatile memory, a cache memory, a buffer, a short term memory unit, a long term memory unit, or other suitable memory units. Storage unit 195 and/or storage unit 185 may include, for example, a hard disk drive, a floppy disk drive, a Compact Disk (CD) drive, a CD-ROM drive, a DVD drive, or other suitable removable or non-removable storage units. Memory unit 194 and/or storage unit 195, for example, may store data processed by device 102. Memory unit 184 and/or storage unit 185, for example, may store data processed by device 140.

In some demonstrative aspects, wireless communication devices 102 and/or 140 may be capable of communicating content, data, information and/or signals via a wireless medium (WM) 103. In some demonstrative aspects, wireless medium 103 may include, for example, a radio channel, an RF channel, a WiFi channel, a cellular channel, a 5G channel, an IR channel, a Bluetooth (BT) channel, a Global Navigation Satellite System (GNSS) Channel, and the like.

In some demonstrative aspects, WM 103 may include one or more wireless communication frequency bands and/or channels. For example, WM 103 may include one or more channels in a sub-10 Ghz wireless communication frequency band, for example, one or more channels in a 2.4 GHz wireless communication frequency band, one or more channels in a 5 GHz wireless communication frequency band, and/or one or more channels in a 6 GHz wireless communication frequency band. For example, WM 103 may additionally or alternatively include one or more channels in a mmWave wireless communication frequency band.

In other aspects, WM 103 may include any other type of channel over any other frequency band.

In some demonstrative aspects, device 102 and/or device 140 may include one or more radios including circuitry and/or logic to perform wireless communication between devices 102, 140 and/or one or more other wireless communication devices. For example, device 102 may include one or more radios 114, and/or device 140 may include one or more radios 144.

In some demonstrative aspects, radios 114 and/or 144 may include one or more wireless receivers (Rx) including circuitry and/or logic to receive wireless communication signals, RF signals, frames, blocks, transmission streams, packets, messages, data items, and/or data. For example, a radio 114 may include at least one receiver 116, and/or a radio 144 may include at least one receiver 146.

In some demonstrative aspects, radios 114 and/or 144 may include one or more wireless transmitters (Tx) including circuitry and/or logic to transmit wireless communication signals, RF signals, frames, blocks, transmission streams, packets, messages, data items, and/or data. For example, a radio 114 may include at least one transmitter 118, and/or a radio 144 may include at least one transmitter 148.

In some demonstrative aspects, radios 114 and/or 144, transmitters 118 and/or 148, and/or receivers 116 and/or 146 may include circuitry; logic; Radio Frequency (RF) elements, circuitry and/or logic; baseband elements, circuitry and/or logic; modulation elements, circuitry and/or logic; demodulation elements, circuitry and/or logic; amplifiers; analog to digital and/or digital to analog converters; filters; and/or the like. For example, radios 114 and/or 144 may include or may be implemented as part of a wireless Network Interface Card (NIC), and the like.

In some demonstrative aspects, radios 114 and/or 144 may be configured to communicate over a sub-10 Ghz band, for example, 2.4 GHz band, a 5 GHz band, a 6 GHz band, and/or any other sub-10 GHz band; and/or an mmWave band, e.g., a 45 Ghz band, a 60 Ghz band, and/or any other mmWave band; and/or any other band, e.g., a 5G band, an S1G band, and/or any other band.

In some demonstrative aspects, radios 114 and/or 144 may include, or may be associated with one or more, e.g., a plurality of, antennas.

In some demonstrative aspects, device 102 may include one or more, e.g., a plurality of, antennas 107, and/or device 140 may include one or more, e.g., a plurality of, antennas 147.

Antennas 107 and/or 147 may include any type of antennas suitable for transmitting and/or receiving wireless communication signals, blocks, frames, transmission streams, packets, messages and/or data. For example, antennas 107 and/or 147 may include any suitable configuration, structure and/or arrangement of one or more antenna elements, components, units, assemblies and/or arrays. In some aspects, antennas 107 and/or 147 may implement transmit and receive functionalities using separate transmit and receive antenna elements. In some aspects, antennas 107 and/or 147 may implement transmit and receive functionalities using common and/or integrated transmit/receive elements.

In some demonstrative aspects, device 102 may include a controller 124, and/or device 140 may include a controller 154. Controller 124 may be configured to perform and/or to trigger, cause, instruct and/or control device 102 to perform, one or more communications, to generate and/or communicate one or more messages and/or transmissions, and/or to perform one or more functionalities, operations and/or procedures between devices 102, 140 and/or one or more other devices; and/or controller 154 may be configured to perform, and/or to trigger, cause, instruct and/or control device 140 to perform, one or more communications, to generate and/or communicate one or more messages and/or transmissions, and/or to perform one or more functionalities, operations and/or procedures between devices 102, 140 and/or one or more other devices, e.g., as described below.

In some demonstrative aspects, controllers 124 and/or 154 may include, or may be implemented, partially or entirely, by circuitry and/or logic, e.g., one or more processors including circuitry and/or logic, memory circuitry and/or logic, Media-Access Control (MAC) circuitry and/or logic, Physical Layer (PHY) circuitry and/or logic, baseband (BB) circuitry and/or logic, a BB processor, a BB memory, Application Processor (AP) circuitry and/or logic, an AP processor, an AP memory, and/or any other circuitry and/or logic, configured to perform the functionality of controllers 124 and/or 154, respectively. Additionally or alternatively, one or more functionalities of controllers 124 and/or 154 may be implemented by logic, which may be executed by a machine and/or one or more processors, e.g., as described below.

In one example, controller 124 may include circuitry and/or logic, for example, one or more processors including circuitry and/or logic, to cause, trigger and/or control a wireless device, e.g., device 102, and/or a wireless station, e.g., a wireless STA implemented by device 102, to perform one or more operations, communications and/or functionalities, e.g., as described herein. In one example, controller 124 may include at least one memory, e.g., coupled to the one or more processors, which may be configured, for example, to store, e.g., at least temporarily, at least some of the information processed by the one or more processors and/or circuitry, and/or which may be configured to store logic to be utilized by the processors and/or circuitry.

In one example, controller 154 may include circuitry and/or logic, for example, one or more processors including circuitry and/or logic, to cause, trigger and/or control a wireless device, e.g., device 140, and/or a wireless station, e.g., a wireless STA implemented by device 140, to perform one or more operations, communications and/or functionalities, e.g., as described herein. In one example, controller 154 may include at least one memory, e.g., coupled to the one or more processors, which may be configured, for example, to store, e.g., at least temporarily, at least some of the information processed by the one or more processors and/or circuitry, and/or which may be configured to store logic to be utilized by the processors and/or circuitry.

In some demonstrative aspects, at least part of the functionality of controller 124 may be implemented as part of one or more elements of radio 114, and/or at least part of the functionality of controller 154 may be implemented as part of one or more elements of radio 144.

In other aspects, the functionality of controller 124 may be implemented as part of any other element of device 102, and/or the functionality of controller 154 may be implemented as part of any other element of device 140.

In some demonstrative aspects, device 102 may include a message processor 128 configured to generate, process and/or access one or more messages communicated by device 102.

In one example, message processor 128 may be configured to generate one or more messages to be transmitted by device 102, and/or message processor 128 may be configured to access and/or to process one or more messages received by device 102, e.g., as described below.

In one example, message processor 128 may include at least one first component configured to generate a message, for example, in the form of a frame, field, information element and/or protocol data unit, for example, a MAC Protocol Data Unit (MPDU); at least one second component configured to convert the message into a PHY Protocol Data Unit (PPDU), for example, by processing the message generated by the at least one first component, e.g., by encoding the message, modulating the message and/or performing any other additional or alternative processing of the message; and/or at least one third component configured to cause transmission of the message over a wireless communication medium, e.g., over a wireless communication channel in a wireless communication frequency band, for example, by applying to one or more fields of the PPDU one or more transmit waveforms. In other aspects, message processor 128 may be configured to perform any other additional or alternative functionality and/or may include any other additional or alternative components to generate and/or process a message to be transmitted.

In some demonstrative aspects, device 140 may include a message processor 158 configured to generate, process and/or access one or more messages communicated by device 140.

In one example, message processor 158 may be configured to generate one or more messages to be transmitted by device 140, and/or message processor 158 may be configured to access and/or to process one or more messages received by device 140, e.g., as described below.

In one example, message processor 158 may include at least one first component configured to generate a message, for example, in the form of a frame, field, information element and/or protocol data unit, for example, an MPDU; at least one second component configured to convert the message into a PPDU, for example, by processing the message generated by the at least one first component, e.g., by encoding the message, modulating the message and/or performing any other additional or alternative processing of the message; and/or at least one third component configured to cause transmission of the message over a wireless communication medium, e.g., over a wireless communication channel in a wireless communication frequency band, for example, by applying to one or more fields of the PPDU one or more transmit waveforms. In other aspects, message processor 158 may be configured to perform any other additional or alternative functionality and/or may include any other additional or alternative components to generate and/or process a message to be transmitted.

In some demonstrative aspects, message processors 128 and/or 158 may include, or may be implemented, partially or entirely, by circuitry and/or logic, e.g., one or more processors including circuitry and/or logic, memory circuitry and/or logic, MAC circuitry and/or logic, PHY circuitry and/or logic, BB circuitry and/or logic, a BB processor, a BB memory, AP circuitry and/or logic, an AP processor, an AP memory, and/or any other circuitry and/or logic, configured to perform the functionality of message processors 128 and/or 158, respectively. Additionally or alternatively, one or more functionalities of message processors 128 and/or 158 may be implemented by logic, which may be executed by a machine and/or one or more processors, e.g., as described below.

In some demonstrative aspects, at least part of the functionality of message processor 128 may be implemented as part of radio 114, and/or at least part of the functionality of message processor 158 may be implemented as part of radio 144.

In some demonstrative aspects, at least part of the functionality of message processor 128 may be implemented as part of controller 124, and/or at least part of the functionality of message processor 158 may be implemented as part of controller 154.

In other aspects, the functionality of message processor 128 may be implemented as part of any other element of device 102, and/or the functionality of message processor 158 may be implemented as part of any other element of device 140.

In some demonstrative aspects, at least part of the functionality of controller 124 and/or message processor 128 may be implemented by an integrated circuit, for example, a chip, e.g., a System on Chip (SoC). In one example, the chip or SoC may be configured to perform one or more functionalities of one or more radios 114. For example, the chip or SoC may include one or more elements of controller 124, one or more elements of message processor 128, and/or one or more elements of one or more radios 114. In one example, controller 124, message processor 128, and one or more radios 114 may be implemented as part of the chip or SoC.

In other aspects, controller 124, message processor 128 and/or the one or more radios 114 may be implemented by one or more additional or alternative elements of device 102.

In some demonstrative aspects, at least part of the functionality of controller 154 and/or message processor 158 may be implemented by an integrated circuit, for example, a chip, e.g., a SoC. In one example, the chip or SoC may be configured to perform one or more functionalities of one or more radios 144. For example, the chip or SoC may include one or more elements of controller 154, one or more elements of message processor 158, and/or one or more elements of one or more radios 144. In one example, controller 154, message processor 158, and one or more radios 144 may be implemented as part of the chip or SoC.

In other aspects, controller 154, message processor 158 and/or one or more radios 144 may be implemented by one or more additional or alternative elements of device 140.

In some demonstrative aspects, device 102 and/or device 140 may include, operate as, perform the role of, and/or perform one or more functionalities of, one or more STAs. For example, device 102 may include at least one STA, and/or device 140 may include at least one STA.

In some demonstrative aspects, device 102 and/or device 140 may include, operate as, perform the role of, and/or perform one or more functionalities of, one or more Extremely High Throughput (EHT) STAs. For example, device 102 may include, operate as, perform the role of, and/or perform one or more functionalities of, one or more EHT STAs, and/or device 140 may include, operate as, perform the role of, and/or perform one or more functionalities of, one or more EHT STAs.

In some demonstrative aspects, device 102 and/or device 140 may include, operate as, perform the role of, and/or perform one or more functionalities of, one or more mmWave STAs, e.g., DMG STAs, EDMG STAs, and/or any other mmWave STA. For example, device 102 may include, operate as, perform the role of, and/or perform one or more functionalities of, one or more mmWave STAs, and/or device 140 may include, operate as, perform the role of, and/or perform one or more functionalities of, one or more mmWave STAs.

In other aspects, devices 102 and/or 140 may include, operate as, perform the role of, and/or perform one or more functionalities of, any other wireless device and/or station, e.g., a WLAN STA, a WiFi STA, and the like.

In some demonstrative aspects, device 102 and/or device 140 may be configured to operate as, perform the role of, and/or perform one or more functionalities of, an access point (AP), e.g., an EHT AP STA.

In some demonstrative aspects, device 102 and/or device 140 may be configured to operate as, perform the role of, and/or perform one or more functionalities of, a non-AP STA, e.g., an EHT non-AP STA.

In other aspects, device 102 and/or device 140 may operate as, perform the role of, and/or perform one or more functionalities of, any other additional or alternative device and/or station.

In one example, a station (STA) may include a logical entity that is a singly addressable instance of a medium access control (MAC) and physical layer (PHY) interface to the wireless medium (WM). The STA may perform any other additional or alternative functionality.

In one example, an AP may include an entity that contains one station (STA) and provides access to the distribution services, via the wireless medium (WM) for associated STAs. An AP may include a STA and a distribution system access function (DSAF). The AP may perform any other additional or alternative functionality.

In some demonstrative aspects devices 102 and/or 140 may be configured to communicate in an EHT network, and/or any other network.

In some demonstrative aspects, devices 102 and/or 140 may be configured to operate in accordance with one or more Specifications, for example, including one or more IEEE 802.11 Specifications, e.g., an IEEE 802.11-2020 Specification, an IEEE 802.11be Specification, an IEEE 802.11ay Specification and/or any other specification and/or protocol.

In some demonstrative aspects, device 102 and/or device 140 may include, operate as, perform a role of, and/or perform the functionality of, one or more multi-link logical entities, e.g., as described below.

In other aspect, device 102 and/or device 140 may include, operate as, perform a role of, and/or perform the functionality of, any other entities, e.g., which are not multi-link logical entities.

For example, a multi-link logical entity may include a logical entity that contains one or more STAs. The logical entity may have one MAC data service interface and primitives to the logical link control (LLC) and a single address associated with the interface, which can be used to communicate on a distribution system medium (DSM). For example, the DSM may include a medium or set of media used by a distribution system (DS) for communications between APs, mesh gates, and the portal of an extended service set (ESS). For example, the DS may include a system used to interconnect a set of basic service sets (BSSs) and integrated local area networks (LANs) to create an extended service set (ESS). In one example, a multi-link logical entity may allow STAs within the multi-link logical entity to have the same MAC address. The multi-link entity may perform any other additional or alternative functionality.

In some demonstrative aspects, device 102 and/or device 140 may include, operate as, perform a role of, and/or perform the functionality of, a Multi-Link Device (MLD). For example, device 102 may include, operate as, perform a role of, and/or perform the functionality of, at least one MLD, and/or device 140 may include, operate as, perform a role of, and/or perform the functionality of, at least one MLD, e.g., as described below.

For example, an MLD may include a device that is a logical entity and has more than one affiliated STA and has a single MAC service access point (SAP) to LLC, which includes one MAC data service. The MLD may perform any other additional or alternative functionality.

In some demonstrative aspects, for example, an infrastructure framework may include a multi-link AP logical entity, which includes APs, e.g., on one side, and a multi-link non-AP logical entity, which includes non-APs, e.g., on the other side.

In some demonstrative aspects, device 102 and/or device 140 may be configured to operate as, perform the role of, and/or perform one or more functionalities of, an AP MLD.

In some demonstrative aspects, device 102 and/or device 140 may be configured to operate as, perform the role of, and/or perform one or more functionalities of, a non-AP MLD.

In other aspects, device 102 and/or device 140 may operate as, perform the role of, and/or perform one or more functionalities of, any other additional or alternative device and/or station.

For example, an AP MLD may include an MLD, where each STA affiliated with the MLD is an AP. In one example, the AP MLD may include a multi-link logical entity, where each STA within the multi-link logical entity is an EHT AP. The AP MLD may perform any other additional or alternative functionality.

For example, a non-AP MLD may include an MLD, where each STA affiliated with the MLD is a non-AP STA. In one example, the non-AP MLD may include a multi-link logical entity, where each STA within the multi-link logical entity is a non-AP EHT STA. The non-AP MLD may perform any other additional or alternative functionality.

In one example, a multi-link infrastructure framework may be configured as an extension from a one link operation between two STAs, e.g., an AP and a non-AP STA.

In some demonstrative aspects, controller 124 may be configured to control, perform and/or to trigger, cause, instruct and/or control device 102 to operate as, perform a role of, and/or perform one or more operations and/or functionalities of, an AP MLD 131 including a plurality of STAs 133, e.g., including an AP STA 135, an AP STA 137, an AP STA 139, and/or an mmWave STA 141. In some aspects, as shown in FIG. 1, AP MLD 131 may include four STAs. In other aspects, AP MLD 131 may include any other number of STAs.

In one example, AP STA 135, AP STA 137, AP STA 139, and/or mmWave STA 141 may operate as, perform a role of, and/or perform one or more operations and/or functionalities of, an EHT AP STA. In other aspects, AP STA 135, AP STA 137, AP STA 139, and/or mmWave STA 141 may perform any other additional or alternative functionality.

In some demonstrative aspects, mmWave STA 141 may operate as, perform a role of, and/or perform one or more operations and/or functionalities of, a mmWave AP STA. In other aspects, mmWave STA 141 may operate as, perform a role of, and/or perform one or more operations and/or functionalities of an mmWave network controller to control communication over an mmWave wireless communication network.

In some demonstrative aspects, for example, the one or more radios 114 may include, for example, a radio for communication by AP STA 135 over a first wireless communication frequency channel and/or frequency band, e.g., a 2.4 Ghz band, as described below.

In some demonstrative aspects, for example, the one or more radios 114 may include, for example, a radio for communication by AP STA 137 over a second wireless communication frequency channel and/or frequency band, e.g., a 5 Ghz band, as described below.

In some demonstrative aspects, for example, the one or more radios 114 may include, for example, a radio for communication by AP STA 139 over a third wireless communication frequency channel and/or frequency band, e.g., a 6 Ghz band, as described below.

In some demonstrative aspects, for example, the one or more radios 114 may include, for example, a radio for communication by mmWave STA 141 over a fourth wireless communication frequency channel and/or frequency band, e.g., an mmWave band, for example, a wireless communication band above 45 Ghz, for example, a 6-GHz band or any other mmWave band, e.g., as described below.

In some demonstrative aspects, the radios 114 utilized by STAs 133 may be implemented as separate radios. In other aspects, the radios 114 utilized by STAs 133 may be implemented by one or more shared and/or common radios and/or radio components.

In other aspects controller 124 may be configured to control, perform and/or to trigger, cause, instruct and/or control device 102 to operate as, perform a role of, and/or perform one or more operations and/or functionalities of, any other additional or alternative entity and/or STA, e.g., a single STA, multiple STAs, and/or a non-MLD entity.

In some demonstrative aspects, controller 154 may be configured to control, perform and/or to trigger, cause, instruct and/or control device 140 to operate as, perform a role of, and/or perform one or more operations and/or functionalities of, an MLD 151 including a plurality of STAs 153, e.g., including a STA 155, a STA 157, a STA 159, and/or a STA 161. In some aspects, as shown in FIG. 1, MLD 151 may include four STAs. In other aspects, MLD 151 may include any other number of STAs.

In one example, STA 155, STA 157, STA 159, and/or STA 161 may operate as, perform a role of, and/or perform one or more operations and/or functionalities of, an EHT STA. In other aspects, STA 155, STA 157, STA 159, and/or STA 161 may perform any other additional or alternative functionality.

In some demonstrative aspects, STA 161 may be configured to operate as, perform a role of, and/or perform one or more operations and/or functionalities of, an mmWave STA, e.g., as described below. For example, the mmWave STA 161 may be configured to operate as, perform a role of, and/or perform one or more operations and/or functionalities of, a non-AP mmWave STA, e.g., as described below.

In some demonstrative aspects, for example, the one or more radios 144 may include, for example, a radio for communication by STA 155 over a first wireless communication frequency channel and/or frequency band, e.g., a 2.4 Ghz band, as described below.

In some demonstrative aspects, for example, the one or more radios 144 may include, for example, a radio for communication by STA 157 over a second wireless communication frequency channel and/or frequency band, e.g., a 5 Ghz band, as described below.

In some demonstrative aspects, for example, the one or more radios 144 may include, for example, a radio for communication by STA 159 over a third wireless communication frequency channel and/or frequency band, e.g., a 6 Ghz band, as described below.

In some demonstrative aspects, for example, the one or more radios 144 may include, for example, a radio for communication by mmWave STA 161 over a fourth wireless communication frequency channel and/or frequency band, e.g., a mmWave band, as described below.

In some demonstrative aspects, the radios 144 utilized by STAs 153 may be implemented as separate radios. In other aspects, the radios 144 utilized by STAs 153 may be implemented by one or more shared and/or common radios and/or radio components.

In some demonstrative aspects, controller 154 may be configured to control, perform and/or to trigger, cause, instruct and/or control MLD 151 to operate as, perform a role of, and/or perform one or more operations and/or functionalities of, a non-AP MLD. For example, STA 155, STA 157, STA 159, and/or mmWave STA 161 may operate as, perform a role of, and/or perform one or more operations and/or functionalities of, a non-AP STA, e.g., a non-AP EHT STA.

In some demonstrative aspects, controller 154 may be configured to control, perform and/or to trigger, cause, instruct and/or control MLD 151 to operate as, perform a role of, and/or perform one or more operations and/or functionalities of, an AP MLD. For example, STA 155, STA 157, STA 159, and/or mmWave STA 161 may operate as, perform a role of, and/or perform one or more operations and/or functionalities of, an AP EHT STA.

In other aspects controller 154 may be configured to control, perform and/or to trigger, cause, instruct and/or control device 140 to operate as, perform a role of, and/or perform one or more operations and/or functionalities of, any other additional or alternative entity and/or STA, e.g., a single STA, multiple STAs, and/or a non-MLD entity.

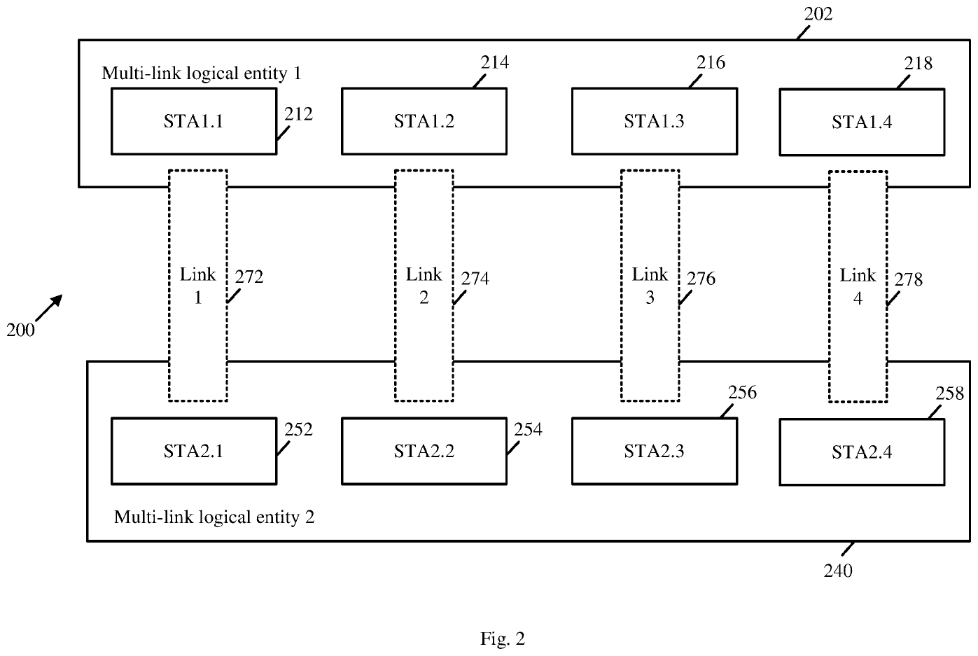

Reference is made to FIG. 2, which schematically illustrates a multi-link communication scheme 200, which may be implemented in accordance with some demonstrative aspects.

As shown in FIG. 2, a first multi-link logical entity 202 (“multi-link logical entity 1”), e.g., a first MLD, may include a plurality of STAs, e.g., including a STA 212, a STA 214, a STA 216, and a STA 218. In one example, AP MLD 131 (FIG. 1) may perform one or more operations of, one or more functionalities of, the role of, and/or the functionality of, multi-link logical entity 202.

As shown in FIG. 2, a second multi-link logical entity 240 (“multi-link logical entity 2”), e.g., a second MLD, may include a plurality of STAs, e.g., including a STA 252, a STA 254, a STA 256, and a STA 258. In one example, MLD 151 (FIG. 1) may perform one or more operations of, one or more functionalities of, the role of, and/or the functionality of, multi-link logical entity 240.

As shown in FIG. 2, multi-link logical entity 202 and multi-link logical entity 240 may be configured to form, setup and/or communicate over a plurality of links, for example, including a link 272 between STA 212 and STA 252, a link 274 between STA 214 and STA 254, a link 276 between STA 216 and STA 256, and/or a link 278 between STA 218 and STA 258.

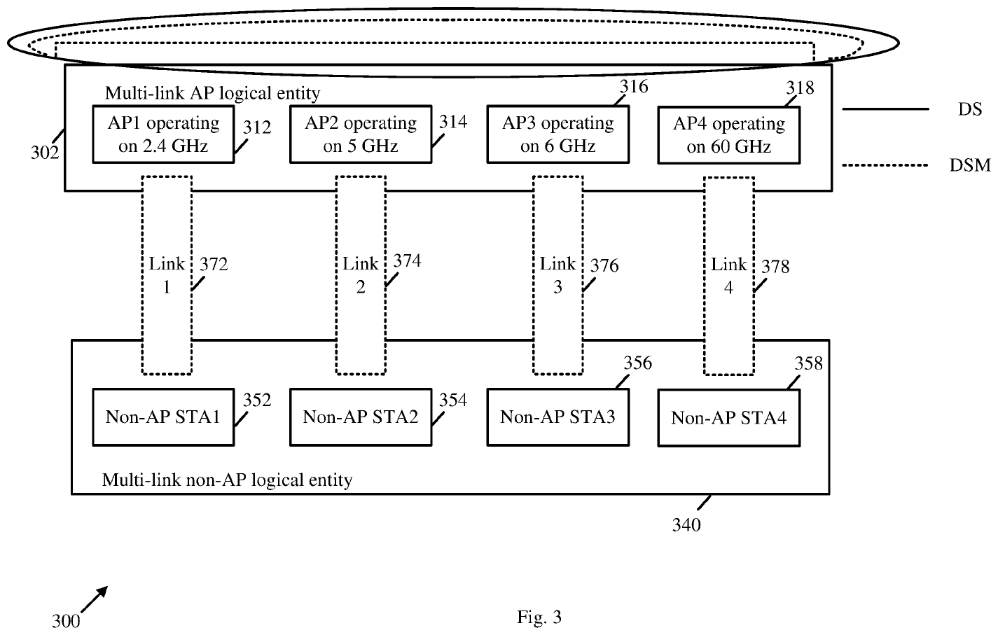

Reference is made to FIG. 3, which schematically illustrates a multi-link communication scheme 300, which may be implemented in accordance with some demonstrative aspects.

As shown in FIG. 3, a multi-link AP logical entity 302, e.g., an AP MLD, may include a plurality of AP STAs, e.g., including an AP STA 312, an AP STA 314, an AP STA 316, and an mmWave STA 318. In one example, AP MLD 131 (FIG. 1) may perform one or more operations of, one or more functionalities of, the role of, and/or the functionality of, multi-link AP logical entity 302.

As shown in FIG. 3, a multi-link non-AP logical entity 340, e.g., a non-AP MLD, may include a plurality of non-AP STAs, e.g., including a non-AP STA 352, a non-AP STA 354, a non-AP STA 356, and an mmWave STA 358. In one example, MLD 151 (FIG. 1) may perform one or more operations of, one or more functionalities of, the role of, and/or the functionality of, multi-link non-AP logical entity 340.

As shown in FIG. 3, multi-link AP logical entity 302 and multi-link non-AP logical entity 340 may be configured to form, setup and/or communicate over a plurality of links, for example, including a link 372 between AP STA 312 and non-AP STA 352, a link 374 between AP STA 314 and non-AP STA 354, a link 376 between AP STA 316 and non-AP STA 356, and/or a link 378 between mmWave STA 318 and mmWave STA 358.

For example, as shown in FIG. 3, multi-link AP logical entity 302 may include a multi-band AP MLD, which may be configured to communicate over a plurality of wireless communication frequency bands. For example, as shown in FIG. 3, AP STA 312 may be configured to communicate over a 2.4 Ghz frequency band, AP STA 314 may be configured to communicate over a 5 Ghz frequency band, AP STA 316 may be configured to communicate over a 6 Ghz frequency band, and/or mmWave STA 318 may be configured to communicate over a mmWave frequency band. In other aspects, AP STA 312, AP STA 314, AP STA 316, and/or mmWave STA 318 may be configured to communicate over any other additional or alternative wireless communication frequency bands.

Referring back to FIG. 1, in some demonstrative aspects, device 102 and/or device 140 may be configured to communicate over a mmWave frequency band according to a mmWave channelization scheme, e.g., as described below.

In some demonstrative aspects, the mmWave channelization scheme may be configured to implement one or more features, definitions, and/or functionalities, which may be compatible with a sub-10 GHz channelization scheme, e.g., as described below.

For example, a sub-7 GHz unlicensed band channelization, e.g., in accordance with one or more IEEE 802.11 Specifications, may utilize a minimum channel bandwidth of 20 MHz, and may include additional channel widths, for example, 40 MHz, 80 MHz, 160 MHz and/or 320 MHz, e.g., depending on the spectrum availability in a sub-7 GHz band, e.g., a 2.4 GHz band, a 5 GHz band, and/or a 6 GHz band.

In one example, the sub-7 GHz unlicensed band channelization may include, e.g., in the 2.4 GHz band, a plurality of 20 MHz channels, which are overlapping.

In another example, the sub-7 GHz unlicensed band channelization may define that channels in the 5 GHz band with the same channel width may not overlap.

In another example, the sub-7 GHz unlicensed band channelization may define that channels in the 6 GHz band with the same channel width may not overlap, e.g., for 320 MHz channels, which may overlap.

For example, the sub-7 GHz unlicensed band channelization may define that support of a 160 MHz bandwidth in the 5 GHz band and/or the 6 GHz band may be mandatory for an EHT AP, e.g., according to the IEEE 802.11be Specification.

For example, the sub-7 GHz unlicensed band channelization may define that support of an 80 MHz bandwidth in the 5 GHz band and/or the 6 GHz band may be mandatory for an EHT non-AP STA, for example, except for a 20 MHZ-only non-AP STA, e.g., according to the IEEE 802.11be Specification.

In some demonstrative aspects, there may be a need to provide a technical solution to configure a channelization scheme for a mmWave band, e.g., the 60 GHz band, to be compatible with a channelization scheme for a sub-10 GHz band, e.g., the sub-7 GHz band.

For example, a mmWave channelization scheme, which is not compatible with a sub-10 GHz channelization scheme may result in a technical issue requiring different PHY and/or different MAC design for a 60 GHz radio and a sub-7 GHz radio, e.g., which may result in a different chip core design.

For example, there may be a technical problem to utilize an existing sub-7 GHz Wi-Fi design for a 60 GHz design, e.g., according to the IEEE 802.11ad/802.11ay Specification.

In some demonstrative aspects, device 102 and/or device 140 may be configured to utilize a mmWave channelization scheme, which may be configured to reuse one or more PHY and/or MAC configurations of a sub-10 GHz design for a mmWave design, e.g., as described below.

For example, reusing PHY and/or MAC components of the sub-10 GHz design for the mmWave design may provide a technical solution to reduce, e.g., minimize, cost and/or investment to implement a 60 GHz radio.

In some demonstrative aspects, device 102 and/or device 140 may be configured to utilize a mmWave channelization scheme, which may have a format compatible with a sub-10 GHz channelization scheme, e.g., as described below.

In some demonstrative aspects, the mmWave channelization scheme be configured to support rechannelization of a 60 GHz band, for example, toward a compatible format with a sub-7 GHz band, for example, such that a format defined for the sub-7 GHz band may be utilized for the 60 GHz band e.g., as described below.

In some demonstrative aspects, the mm Wave channelization scheme may be configured to define a minimum channel bandwidth for the 60 GHz band, and a corresponding expansion of one or more wider channels bandwidths, e.g., as described below.

In some demonstrative aspects, the mm Wave channelization scheme may be configured to define a minimum channel bandwidth for the 60 GHz band, which may be wider, for example, than a minimal channel bandwidth defined for the sub-7 GHz band.

For example, a channel in the sub-7 GHz band may be crowded, and, as a result, there may be incumbents. According to this example, a Clear Channel Assessment (CCA) scheme may be utilized to monitor each 20 MHz band that is available in a large bandwidth of a channel bandwidth in the sub-7 GHz band. For example, a device may be allowed to transmit only on available 20 MHz channels with a specific allowed pattern.

For example, the 60 GHz band may include larger channel bandwidths than the sub-7 GHz band, e.g., channel bandwidth as large as 1280 MHz or even more, e.g., as described below.

For example, a CCA scheme design, which suits requirements of the sub-10 GHz band, may be complicate to reuse at the mmWave band, for example, if a minimal channel width of 20 MHz is used.

For example, there may be a technical problem to reuse the CCA scheme design for an 1280 MHz channel width if a minimal channel width of 20 MHz is used. For example, such an implementation may require a device to perform 64 20 MHz CCA measurements, which may be difficult to support.

In some demonstrative aspects, device 102 and/or device 140 may be communicate over the mmWave frequency band according to a mmWave channelization scheme, which may define a minimum channel width much larger than 20 MHz, such as, for example, a minimal channel width of 80 MHz, 160 MHZ, 320 MHz, or any other minimal channel width greater than 20 MHz, e.g., as described below.

In some demonstrative aspects, the mmWave channelization scheme, which defines a minimum channel width larger than 20 MHz, may be implemented to provide a technical solution to simplify a CCA requirement for support of larger bandwidths, e.g., as described below.

In some demonstrative aspects, the mmWave channelization scheme, which defines a minimum channel width larger than 20 MHz, may be implemented to provide a technical solution to simplify a channel bonding design for the 60 GHz band toward larger channel bandwidths, e.g., 320 MHz, 640 MHz, 1280 MHz, and/or any other channel bandwidths, e.g., as described below.

In some demonstrative aspects, the mmWave channelization scheme, which defines a minimum channel width larger than 20 MHz, may be implemented to provide a technical solution to support channelization of non-overlapping larger channel bandwidths, e.g., 320 MHz, 640 MHz, 1280 MHz, and/or any other channel bandwidths, e.g., as described below.

In some demonstrative aspects, device 102 and/or device 140 may be configured to generate, process, transmit, and/or receive one or more mm Wave PPDUs according to a PPDU format restriction scheme in the 60 GHz band, e.g., as described below.

In some demonstrative aspects, the PPDU format restriction scheme may be configured to disallow a non-High Throughput (HT) PPDU format and/or a non-HT duplicate PPDU format in the 60 GHz band, e.g., as described below.

In some demonstrative aspects, the PPDU format restriction scheme may be configured to allow the non-HT PPDU format and/or the non-HT duplicate PPDU format, e.g., with an uplocking version, in the 60 GHz band, e.g., as described below.

In some demonstrative aspects, the PPDU format restriction scheme may be configured to allow over the 60 GHz band communication of one or more predefined PPDU formats, for example, an HT PPDU format, a Very High Throughput (VHT) PPDU format, a High Efficiency (HE) PPDU format, and/or an EHT PPDU format, e.g., as described below.

In some demonstrative aspects, the PPDU format restriction scheme may be configured to disallow over the 60 GHz band communication of one or more predefined PPDU formats, for example, the HT PPDU format, the VHT PPDU format, the HE PPDU format, and/or the EHT PPDU format, e.g., as described below.

In some demonstrative aspects, the PPDU format restriction scheme may be configured to allow a newly defined PPDU format, e.g., a newly defined Wi-Fi 8 PPDU format, to be used by a device to start communication in the 60 GHz band, e.g., as described below.

In some demonstrative aspects, the PPDU format restriction scheme may be configured to disallow the newly defined PPDU format, e.g., the newly defined Wi-Fi 8 PPDU format, to be used by a device to start communication in the 60 GHz band, e.g., as described below.

For example, a non-HT PPDU format and/or a non-HT duplicate PPDU format may be generally allowed in the sub-7 GHz band, e.g., according to an IEEE 802.11 Specification, for example, as the non-HT PPDU format and/or the non-HT duplicate PPDU format may be the only PPDU format that may allow legacy coexistence, e.g., for 20 MHz STAs.

For example, when an HE STA is a first STA to enter a 6 GHz band, a non-HT PPDU may be allowed in a 20 MHz transmission, for example, to accommodate a 20 MHz channelization, e.g., according to an IEEE 802.11 Specification.

In some demonstrative aspects, it may not be efficient to support transmission of a 20 MHz non-HT PPDU and/or a 20 MHz non-HT duplicate PPDU, e.g., for an extremely low data rate, for example, according to a mmWave channelization scheme utilizing a large minimal channel bandwidth, e.g., a bandwidth/minimum channelization starting with 80 MHz, 160 MHz or 320 MHz.

In some demonstrative aspects, the PPDU format restriction scheme may be configured to allow a selected PPDU format, for example, a selected PPDU format from thee HT PPDU format, the VHT PPDU format, the HE PPDU format, the EHT PPDU format, and/or a newly defined PPDU format, e.g., a Wi-Fi 8 PPDU format, to be used to start operation in the 60 GHz band. For example, the PPDU format restriction scheme may be configured to disallow the some or all of the rest of the PPDU formats, e.g., other than the selected PPDU format, to be used to start operation in the 60 GHz band.

For example, the PPDU format restriction scheme may be configured to allow the selected PPDU format and the newly defined PPDU format, e.g., the Wi-Fi 8 PPDU format, to be used to start operation in the 60 GHz band.

For example, the one or more PPDU formats allowed and/or the one or more PPDU formats disallowed according to the PPDU format restriction scheme may be defined, for example, based on a consideration on which frame format is more suitable for starting the operation in 60 GHz band, for future expansion, and/or based on any other consideration and/or criteria.

For example, the PPDU format restriction scheme may be configured to allow using the VHT PPDU format, e.g., without 4 times symbol duration, for example, to provide a relatively easy format to start the operation in the 60 GHz band.

For example, the PPDU format restriction scheme may be configured to allow the EHT PPDU preamble structure, e.g., with a common preamble, for example, to support future expansion and/or a latest feature enabled implementation.

In some demonstrative aspects, device 102 and/or device 140 may be configured to communicate over the mmWave band using a newly defined duplicate PPDU format (mmWave duplicate format), which may be defined, for example, corresponding to a PHY format which is allowed in the 60 GHz band, e.g., the selected PPDU format described above.

For example, the mmWave duplicate PPDU format may be configured, for example, to replace the functionality of the non-HT duplicate PPDU format, e.g., in the sub-7 GHz band.

In some demonstrative aspects, device 102 and/or device 140 may be configured to generate, process, transmit, and/or receive one or more mm Wave PPDUs according to an mmWave channelization scheme, e.g., as described below.

In some demonstrative aspects, device 102 and/or device 140 may be configured to generate, process, transmit, and/or receive one or more mm Wave PPDUs according to an mmWave channelization scheme, which may be compatible with a sub-10 GHz channelization scheme, e.g., as described below.

In some demonstrative aspects, device 102 and/or device 140 may be configured to generate an mmWave PPDU configured for transmission over an mmWave wireless communication channel according to an mmWave channelization scheme, e.g., as described below.

For example, controller 124 may be configured to control, trigger, cause, and/or instruct a wireless communication device implemented by device 102 to generate an mmWave PPDU configured for transmission over an mmWave wireless communication channel according to an mmWave channelization scheme, e.g., as described below.

For example, controller 154 may be configured to control, trigger, cause, and/or instruct a wireless communication device implemented by device 140 to generate an mmWave PPDU configured for transmission over an mmWave wireless communication channel according to an mmWave channelization scheme, e.g., as described below.

In some demonstrative aspects, the mmWave channelization scheme may be configured to define a plurality of mmWave channels in an mmWave wireless communication frequency band, e.g., as described below.

In some demonstrative aspects, the plurality of mmWave channels may be based on a minimal mmWave channel BW, e.g., as described below.

In some demonstrative aspects, the minimal mmWave channel BW may be equal to or greater than 80 MHz and not more than 640 MHz, e.g., as described below.

In some demonstrative aspects, device 102 and/or device 140 may be configured to transmit the mmWave PPDU over the mmWave wireless communication channel, e.g., as described below.

For example, controller 124 may be configured to control, trigger, cause, and/or instruct the wireless communication device implemented by device 102 to transmit the mmWave PPDU over the mmWave wireless communication channel, e.g., as described below.

In some demonstrative aspects, controller 154 may be configured to control, trigger, cause, and/or instruct the wireless communication device implemented by device 140 transmit the mmWave PPDU over the mmWave wireless communication channel, e.g., as described below.

In some demonstrative aspects, channel BWs of the plurality of mmWave channels may be configured as integer multiples of the minimal mmWave channel BW, e.g., as described below.

In some demonstrative aspects, the minimal mmWave channel BW may be configured as integer multiples of 80 MHz, e.g., as described below.

In some demonstrative aspects, the minimal mmWave channel BW may be 80 MHz, e.g., as described below.

In some demonstrative aspects, the minimal mmWave channel BW may be 160 MHz, e.g., as described below.

In other aspects, the minimal mmWave channel BW may be defined as any other minimal channel bandwidth, e.g., equal to or greater than 80 MHz.

In some demonstrative aspects, a wireless communication device, e.g., device 102 and/or device 140, may be configured to transmit the mmWave PPDU over the mmWave wireless communication channel, for example, by reusing one or more elements of a sub-10 GHz PHY of the wireless communication device, e.g., as described below.

In some demonstrative aspects, the mmWave channelization scheme may include a channel structure compatible with a channel structure of a sub-10 GHz channelization scheme, e.g., as described below.

In some demonstrative aspects, the mmWave wireless communication frequency band may include a 60 GHz frequency band, e.g., as described below.

In some demonstrative aspects, the mmWave wireless communication frequency band may include a 14 GHz frequency bandwidth, e.g., as described below.

In other aspects, the mmWave wireless communication frequency band may include any other mmWave band having any other frequency bandwidth.

In some demonstrative aspects, the plurality of mmWave channels may include a plurality of nonoverlapping minimal-BW channels having the minimal mmWave channel BW, e.g., as described below.

In some demonstrative aspects, the plurality of nonoverlapping minimal-BW channels may include more than 20 nonoverlapping minimal-BW channels, e.g., as described below.

In other aspects, the plurality of nonoverlapping minimal-BW channels may include any other additional or alternative number of nonoverlapping minimal-BW channels.

In some demonstrative aspects, the plurality of mmWave channels may include a plurality of wide channels, e.g., as described below.

In some demonstrative aspects, each wide channel of the plurality of wide channels may have a wide channel BW which is at least double the minimal mmWave channel BW, e.g., as described below.

In some demonstrative aspects, all wide channels having a same channel BW may be nonoverlapping, e.g., as described below.

In some demonstrative aspects, the plurality of wide channels may include first and second partially overlapping wide channels having a same channel BW, e.g., as described below.

In some demonstrative aspects, the plurality of mmWave channels may include a plurality of 2×-wide channels, each having a channel BW which is double the minimal mmWave channel BW, e.g., as described below.

In some demonstrative aspects, the plurality of mmWave channels may include a plurality of nonoverlapping 2×-wide channels, each having a channel BW which is double the minimal mmWave channel BW, e.g., as described below.

In some demonstrative aspects, a 2×-wide channel may be configured to cover two minimal-BW channels having the minimal mmWave channel BW, e.g., as described below.

In some demonstrative aspects, the plurality of mmWave channels may include a plurality of 4×-wide channels, each having a channel BW which is 4 times the minimal mmWave channel BW, e.g., as described below.

In some demonstrative aspects, the plurality of mmWave channels may include a plurality of nonoverlapping 4×-wide channels, each having a channel BW which is 4 times the minimal mmWave channel BW, e.g., as described below.

In some demonstrative aspects, a 4×-wide channel may be configured to cover 4 minimal BW channels having the minimal mmWave channel BW. e.g., as described below.

In some demonstrative aspects, the plurality of mmWave channels may include a plurality of 8×-wide channels, each having a channel BW which is 8 times the minimal mmWave channel BW, e.g., as described below.

In some demonstrative aspects, the plurality of mmWave channels may include a plurality of nonoverlapping 8×-wide channels, each having a channel BW which is 8 times the minimal mmWave channel BW, e.g., as described below.

In some demonstrative aspects, an 8×-wide channel may be configured to cover 8 minimal BW channels having the minimal mmWave channel BW, e.g., as described below.

In some demonstrative aspects, the plurality of mmWave channels may include a plurality of 16×-wide channels, each having a channel BW which is 16 times the minimal mmWave channel BW, e.g., as described below.

In some demonstrative aspects, the plurality of mmWave channels may include a plurality of nonoverlapping 16×-wide channels, each having a channel BW which is 16 times the minimal mmWave channel BW, e.g., as described below.

In some demonstrative aspects, a 16×-wide channel may be configured to cover 16 minimal BW channels having the minimal mmWave channel BW, e.g., as described below.

In some demonstrative aspects, the plurality of mmWave channels may include any other additional or alternative wide channels having any other channel bandwidth.

In some demonstrative aspects, the plurality of mmWave channels may include any other additional or alternative channels.

In some demonstrative aspects, device 102 and/or device 140 may be configured to communicate the mmWave PPDUs over the mmWave band according to the mmWave channelization scheme defining a minimum channel width, which is much larger than 20 MHz.

In some demonstrative aspects, the minimum channel width may be 80 MHz, 160 MHz, or 320 MHz.

In some demonstrative aspects, the definition of the minimum channel width may be used to define the minimum transmission bandwidth in the 60 GHz band, e.g., to be the minimum channel width.

In some demonstrative aspects, the mmWave channelization scheme may define nonoverlapping channelization for the minimum channel width.

For example, the mmWave wireless communication frequency band may include 175 160 MHz channels, e.g., in a 14 GHz frequency bandwidth, for example, when the minimum channel width is 80 MHz.

For example, the mmWave wireless communication frequency band may include 87 160 MHz channels, e.g., in the 14 GHz frequency bandwidth, for example, when the minimum channel width is 160 MHz.

For example, the mmWave wireless communication frequency band may include 43 320 MHz channels, e.g., in the 14 GHz frequency bandwidth, for example, when the minimum channel width is 320 MHz.

In other aspects, any other number of any other mmWave channels may be defined according to the minimum channel width and/or according to any other mmWave frequency bandwidth.

In some demonstrative aspects, the mmWave channelization scheme may define nonoverlapping channelization for multiples of the minimum channel width, e.g., 2, 4, 8, and/or 16 times the minimum channel width.

For example, the mmWave channelization scheme may include a plurality of minimal-width channels, e.g., each having the minimum channel width, which may be may be labeled with a respective plurality of channel numbers, e.g., from 1 to X.

For example, a channel width of two times the minimum channel width may be formed by a combination of two minimum-width channels, e.g., channels y and y+1, wherein y is 1, 3, 5, 7, etc.

For example, a channel width of four times the minimum channel width may be formed by a combination of four minimum-width channels, e.g., channels y, y+1, y+2, and y+3, wherein y is 1, 5, 9, 13, etc.

For example, a channel width of eight times the minimum channel width may be formed by a combination of eight minimum-width channels, e.g., channels y, y+1, y+2, y+3, . . . y+7, wherein y is 1, 9, 17, etc.

For example, a channel width of sixteen times the minimum channel width may be formed by a combination of sixteen minimum-width channels, e.g., channels y, y+1, y+2, y+3, . . . y+15, where y is 1, 17, 33, etc.

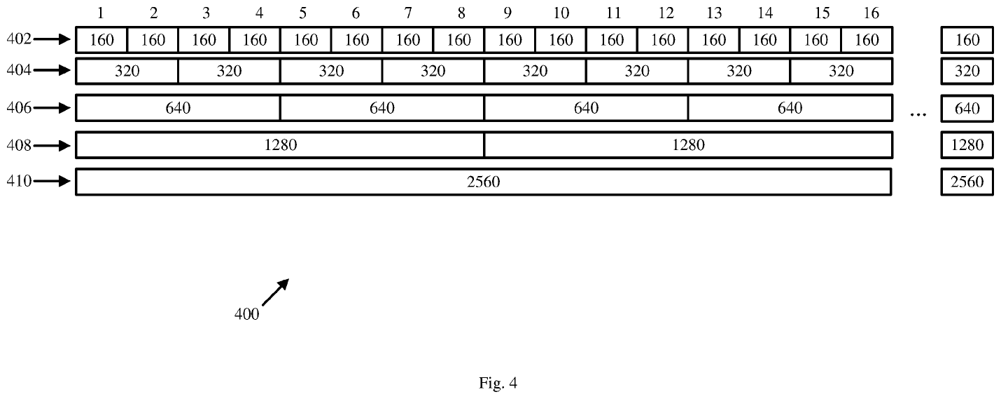

Reference is made to FIG. 4, which schematically illustrates mmWave channels according to a mmWave channelization scheme 400, in accordance with some demonstrative aspects.

For example, device 102 (FIG. 1) and/or device 140 (FIG. 1) may be configured to communicate mmWave PPDUs over one or more mmWave channels according to the mmWave channelization scheme 400.

In some demonstrative aspects, as shown in FIG. 4, the mmWave channelization scheme 400 may include a plurality of minimal-BW channels, e.g., including a plurality of 160 MHz channels 402.

For example, as shown in FIG. 4, the plurality of 160 MHz channels 402 may include a plurality of non-overlapping 160 MHz channels.

In some demonstrative aspects, the mmWave channelization scheme 400may include a plurality of 2×-width channels, e.g., each having a channel BW which is double the minimal mmWave channel BW.

For example, as shown in FIG. 4, the plurality of 2×-width channels may include a plurality of 320 MHz channels 404.

For example, as shown in FIG. 4, the plurality of 320 MHz channels 404 may include a plurality of non-overlapping 320 MHz channels.

For example, as shown in FIG. 4, a 320 MHz channel of the plurality of 320 MHz channels 404 may include two contiguous 160 MHz channels 402.

In some demonstrative aspects, the mmWave channelization scheme 400may include a plurality of 4×-width channels, e.g., each having a channel BW which is four times the minimal mm Wave channel BW.

For example, as shown in FIG. 4, the plurality of 4×-width channels may include a plurality of 640 MHz channels 406.

For example, as shown in FIG. 4, the plurality of 640 MHz channels 406 may include a plurality of non-overlapping 640 MHz channels.

For example, as shown in FIG. 4, a 640 MHz channel of the plurality of 640 MHz channels 406 may include four contiguous 160 MHz channels 402.

In some demonstrative aspects, the mmWave channelization scheme 400may include a plurality of 8×-width channels, e.g., each having a channel BW which is eight times the minimal mmWave channel BW.

For example, as shown in FIG. 4, the plurality of 8×-width channels may include a plurality of 1280 MHz channels 408.

For example, as shown in FIG. 4, the plurality of 1280 MHz channels 408 may include a plurality of non-overlapping 1280 MHz channels.

For example, as shown in FIG. 4, a 1280 MHz channel of the plurality of 1280 MHz channels 408 may include eight contiguous 160 MHz channels 402.

In some demonstrative aspects, the mmWave channelization scheme 400may include a plurality of 16×-width channels, e.g., each having a channel BW which is sixteen times the minimal mmWave channel BW.

For example, as shown in FIG. 4, the plurality of 16×-width channels may include a plurality of 2560 MHz channels 410.

For example, as shown in FIG. 4, the plurality of 2560 MHz channels 410 may include a plurality of non-overlapping 2560 MHz channels.

For example, as shown in FIG. 4, a 2560 MHz channel of the plurality of 2560 MHz channels 410 may include sixteen contiguous 160 MHz channels 402.

Referring back to FIG. 1, in some demonstrative aspects, device 102 and/or device 140 may be configured to communicate mmWave PPDUs over the mmWave wireless communication channel according to the mmWave channelization scheme, which may include a definition of a primary channel BW equal to the minimal mmWave channel BW, and one or more secondary channel BWs, e.g., as described below.

In some demonstrative aspects, the one or more secondary channel BWs may include a secondary channel BW equal to double the minimal mmWave channel BW. e.g., as described below.

In some demonstrative aspects, the one or more secondary channel BWs may include a secondary channel BW equal to four times the minimal mmWave channel BW, e.g., as described below.

In some demonstrative aspects, the one or more secondary channel BWs may include a secondary channel BW equal to eight times the minimal mmWave channel BW, e.g., as described below.

In other aspects, any other secondary channel BW may be used.

In some demonstrative aspects, the mmWave channelization scheme may define a primary channel for the 60 GHz band, for example, based on the minimal mmWave channel bandwidth, e.g., as described below.

In some demonstrative aspects, the primary channel may include an 80 MHz primary channel, for example, minimal mmWave channel bandwidth is 80 MHz.

In some demonstrative aspects, the primary channel may include a 160 MHz primary channel, for example, minimal mmWave channel bandwidth is 160 MHz.

In some demonstrative aspects, the primary channel may include a 320 MHz primary channel, for example, minimal mmWave channel bandwidth is 320 MHz.

In other demonstrative aspects, the primary channel may include any other additional or alternative channel bandwidth.

In some demonstrative aspects, a secondary channel definition and/or access rule for communication over the mmWave channel bandwidth may be defined, for example, in accordance with a secondary channel definition and/or access rule for the sub-10 GHz band.

For example, the secondary channel definition and/or access rule in the sub-7 GHz band may be expanded to 60 GHz, for example, by mapping a channel width of the sub-10 GHz band to a channel width of the mmWave band.

For example, the channel width of 20 MHz in the sub-10 GHz channelization scheme may be mapped to the minimum/channel width of the mmWave channelization scheme.

For example, the channel width of 40 MHz in the sub-10 GHz channelization scheme may be mapped to a 2×-minimum channel width of the mmWave channelization scheme.

For example, the channel width of 80 MHz in the sub-10 GHz channelization scheme may be mapped to a 4×-minimum channel width of the mmWave channelization scheme.

For example, the channel width of 160 MHz in the sub-10 GHz channelization scheme may be mapped to an 8×-minimum channel width of the mmWave channelization scheme.

In one example, the minimum mmWave channel bandwidth may include a channel bandwidth of 160 MHz. According to this example, a secondary 20 MHz channel in the sub-10 GHz channelization scheme may be mapped to a secondary 160 MHz channel in the mmWave channelization scheme. According to this example, a secondary 40 MHz channel in the sub-10 GHz channelization scheme may be mapped to a secondary 320 MHz channel in the mmWave channelization scheme. According to this example, a secondary 80 MHz channel in the sub-10 GHz channelization scheme may be mapped to a secondary 640 MHz channel in the mmWave channelization scheme. According to this example, a secondary 160 MHz channel in the sub-10 GHz channelization scheme may be mapped to a secondary 1280 MHz channel in the mmWave channelization scheme.

In other aspects, any other mapping may be defined to map one or more secondary channels in the sub-10 GHz channelization scheme to one or more secondary channels in the mmWave channelization scheme.

In some demonstrative aspects, device 102 and/or device 140 may be configured to disable transmission of a non-HT duplicate PPDU transmission over the mmWave wireless communication channel, e.g., as described below.

For example, controller 124 may be configured to control, trigger, cause, and/or instruct the wireless communication device implemented by device 102 to disable the wireless communication device to transmit a non-HT duplicate PPDU transmission over the mmWave wireless communication channel.

For example, controller 154 may be configured to control, trigger, cause, and/or instruct the wireless communication device implemented by device 140 to disable the wireless communication device to transmit a non-HT duplicate PPDU transmission over the mmWave wireless communication channel.

In some demonstrative aspects, device 102 and/or device 140 may be configured to disable to transmit over the mmWave wireless communication channel legacy-format PPDUs of at least one disabled legacy PPDU format, e.g., as described below.

For example, controller 124 may be configured to control, trigger, cause, and/or instruct the wireless communication device implemented by device 102 to disable the wireless communication device to transmit over the mmWave wireless communication channel legacy-format PPDUs of the at least one disabled legacy PPDU format.

For example, controller 154 may be configured to control, trigger, cause, and/or instruct the wireless communication device implemented by device 140 to disable the wireless communication device to transmit over the mmWave wireless communication channel legacy-format PPDUs of the at least one disabled legacy PPDU format.

In some demonstrative aspects, the at least one disabled legacy PPDU format may include at least one of an HT PPDU format, a VHT PPDU format, an HE PPDU format, and/or an EHT PPDU format, e.g., as described below.

In some demonstrative aspects, a wireless communication device, e.g., device 102 and/or device 140, may be disabled from including in an mmWave PPDU a capabilities element corresponding to the disabled legacy PPDU format, e.g., as described below.

In some demonstrative aspects, a wireless communication device, e.g., device 102 and/or device 140, may be disabled from including in a mmWave PPDU an operation element corresponding to the disabled legacy PPDU format, e.g., as described below.

For example, controller 124 may be configured to control, trigger, cause, and/or instruct the wireless communication device implemented by device 102 to disable the wireless communication device to include in the mmWave PPDU at least one of a capabilities element corresponding to the disabled legacy PPDU format, or an operation element corresponding to the disabled legacy PPDU format.

For example, controller 154 may be configured to control, trigger, cause, and/or instruct the wireless communication device implemented by device 140 to include in the mmWave PPDU at least one of a capabilities element corresponding to the disabled legacy PPDU format, or an operation element corresponding to the disabled legacy PPDU format.

In some demonstrative aspects, a wireless communication device, e.g., device 102 and/or device 140, may be configured to include an mmWave band capabilities element in a frame transmitted by the wireless communication device, e.g., as described below.

For example, controller 124 may be configured to control, trigger, cause, and/or instruct the wireless communication device implemented by device 102 to include the mmWave band capabilities element in a frame transmitted by the wireless communication device.

For example, controller 154 may be configured to control, trigger, cause, and/or instruct the wireless communication device implemented by device 140 to include the mmWave band capabilities element in a frame transmitted by the wireless communication device.

In some demonstrative aspects, the mmWave band capabilities element may be configured to indicate one or more reused capabilities of the disabled legacy PPDU format, e.g., as described below.

In some demonstrative aspects, a wireless communication device, e.g., device 102 and/or device 140, may be configured to include a mmWave band operation element in a frame transmitted by the wireless communication device, e.g., as described below.

For example, controller 124 may be configured to control, trigger, cause, and/or instruct the wireless communication device implemented by device 102 to include the mmWave band operation element in a frame transmitted by the wireless communication device.

For example, controller 154 may be configured to control, trigger, cause, and/or instruct the wireless communication device implemented by device 140 to include the mmWave band operation element in a frame transmitted by the wireless communication device.

In some demonstrative aspects, the mmWave band operation element may be configured to indicate one or more reused operation information elements of the disabled legacy PPDU format, e.g., as described below.

In some demonstrative aspects, a wireless communication device, e.g., device 102 and/or device 140, may be configured to allow transmission of at least one predefined allowed PPDU format over the mmWave wireless communication channel, e.g., as described below.

For example, controller 124 may be configured to allow the wireless communication device implemented by device 102 to transmit a PPDU of the allowed PPDU format over the mmWave wireless communication channel.

For example, controller 154 may be configured to allow the wireless communication device implemented by device 140 to transmit a PPDU of the allowed PPDU format over the mmWave wireless communication channel.

In some demonstrative aspects, a wireless communication device, e.g., device 102 and/or device 140, may be configured to disallow transmission of at least one predefined disallowed PPDU format over the mmWave wireless communication channel, e.g., as described below.

For example, controller 124 may be configured to disallow the wireless communication device implemented by device 102 to transmit a PPDU of the disallowed PPDU format over the mmWave wireless communication channel.

For example, controller 154 may be configured to disallow the wireless communication device implemented by device 140 to transmit a PPDU of the disallowed PPDU format over the mmWave wireless communication channel.

In some demonstrative aspects, a wireless communication device, e.g., device 102 and/or device 140, may be configured to allow transmission of legacy-format PPDUs of only one allowed legacy PPDU format over the mmWave wireless communication channel. For example, the allowed legacy PPDU format may include only one of an HT PPDU format, a VHT PPDU format, an HE PPDU format, or an EHT PPDU format, e.g., as described below.

In some demonstrative aspects, a wireless communication device, e.g., device 102 and/or device 140, may be configured to allow transmission of a PPDU duplicate transmission, for example, according to the allowed legacy PPDU format, over the mmWave wireless communication channel, e.g., as described below.

In some demonstrative aspects, device 102 and/or device 140 may be configured to transmit a control frame in the PPDU duplicate transmission, for example, according to the allowed legacy PPDU format, e.g., as described below.

In some demonstrative aspects, a wireless communication device, e.g., device 102 and/or device 140, may be configured to allow transmission of upclocked PPDUs of an allowed legacy PPDU format over the mmWave wireless communication channel, e.g., as described below.

In some demonstrative aspects, the allowed legacy PPDU format may include a non-HT PPDU format, an HT PPDU format, a VHT PPDU format, an HE PPDU format, or an EHT PPDU format, e.g., as described below.

In some demonstrative aspects, the upclocked PPDUs of the allowed legacy PPDU format may include an upclocking of a legacy PPDU of the allowed legacy PPDU format, e.g., as described below.

In some demonstrative aspects, the upclocked PPDUs of the allowed legacy PPDU format may include an upclocking of a legacy PPDU of the allowed legacy PPDU format, for example, based on a ratio between the minimal mmWave channel BW and 20 MHz, e.g., as described below.

In some demonstrative aspects, device 102 and/or device 140 may be configured to transmit an mmWave duplicate PPDU transmission over a wide channel covering a plurality of minimal-BW channels having the minimal mmWave channel BW, e.g., as described below.

In some demonstrative aspects, the mmWave duplicate PPDU transmission may include a duplicated transmission, which is duplicated over the plurality of minimal-BW channels, e.g., as described below.

In some demonstrative aspects, the duplicated transmission may include an indication of the wide channel, e.g., as described below.

In some demonstrative aspects, some PPDU formats, e.g., a non-HT PPDU format, an HT PPDU format, a VHT PPDU format, an HE PPDU format, and/or an EHT PPDU format, may be disallowed for communication over the mmWave wireless communication channel, e.g., as described below.

In some demonstrative aspects, an upclock version may be designed for one or more PPDU formats, e.g., for a non-HT PPDU format, an HT PPDU format, a VHT PPDU format, an HE PPDU format, and/or an EHT PPDU format, for example, by increasing a clock rate of a corresponding PPDU defined in the sub-7 GHz band.

For example, the clock rate may be increased by a ratio between a minimum mmWave channel bandwidth and a 20 MHz channel bandwidth.

In one example, the minimum mmWave channel bandwidth may be 160 MHz. According to this example, the clock rate may be increased by eight times.

In another example, the minimum mmWave channel bandwidth may be 302 MHz. According to this example, the clock rate may be increased by sixteen times.

In some demonstrative aspects, one or more of PPDU formats, e.g., one or more of the non-HT PPDU format, the HT PPDU format, the VHT PPDU format, the HE PPDU format, and/or the EHT PPDU format, may be disallowed for communication over the mmWave band.

For example, one or more PPDU formats, for which upclocking is not implemented, may be disallowed for communication over the mmWave band.

In some demonstrative aspects, a capabilities element, e.g., an HT/VHT/HE/EHT/Wi-Fi 8 capabilities element, may be disallowed for communication over the mmWave band, for example, when the capability element corresponds to a PPDU format disallowed for communication over the mmWave band.

In some demonstrative aspects, an operation element, e.g., an HT/VHT/HE/EHT/Wi-Fi 8 operation element, may be disallowed for communication over the mmWave band, for example, when the operation element corresponds to a PPDU format disallowed for communication over the mmWave band.

In some demonstrative aspects, device 102 and/or device 140 may be configured to communicate a newly defined capabilities element, e.g., a Wi-Fi 8 60 GHz capabilities element, corresponding to the mmWave band.

For example, the Wi-Fi 8 60 GHz capabilities element may include information of one or more MAC and/or PHY capabilities.

For example, the Wi-Fi 8 60 GHz capabilities element may reuse MAC and/or PHY capabilities, which may be defined, for example, in an HT/VHT/HE/EHT/Wi-Fi 8 capabilities element, which are disallowed for communication over the mmWave band.

In some demonstrative aspects, device 102 and/or device 140 may be configured to communicate a newly defined operation element, e.g., a Wi-Fi 8 60 GHz operation element, including 60 GHz operation information.

For example, the 60 GHz operation information may include reused operation information, for example, defined in an HT/VHT/HE/EHT/Wi-Fi 8 operation element, which are disallowed for communication over the mmWave band.

In some demonstrative aspects, a duplicate PPDU transmission in the 60 GHz band may be defined with duplicate transmission of mmWave bandwidth for one or more PPDU formats, for example, which are allowed for communication over the mmWave band.

For example, the duplicate PPDU transmission may be defined in the 60 GHz band, for example, with duplicate transmission of minimum bandwidth for one or more allowed PPDU formats, e.g., an HT PPDU format, a VHT PPDU format, an HE PPDU format, an EHT PPDU format, and/or a Wi-Fi 8 PPDU format, e.g., in the 60 GHz band. For example, this duplicate transmission may be defined, for example, if there is no definition of an upclock version of a non-HT or a non-HT duplicate PPDU, e.g., by increasing the clock rate of non-HT or non-HT duplicate PPDU defined in the sub-7 GHz band.

For example, if the minimal mmWave channel BW is defined as 160 MHZ, then a duplicate PPDU transmission may be duplicated on 160 MHz channel BWs forming wider channel BWs, e.g., the mmWave channel BWs 320 MHz, 640 MHZ, 1280 MHz, and/or 2560 MHz. According to this example, the 160 MHz duplicate PPDU transmission may be duplicated on 160 MHz components of the 320/640/1280/2560 MHz bandwidths. For example, this duplicate PPDU transmission may be useful to transmit a control response, e.g., a Clear-Top Send (CTS) response to a Multi-User Request-to Send (MU-RTS) frame, and/or any other control frame.

In some demonstrative aspects, device 102 and/or device 140 may be configured to include a field in the duplicate PPDU on a duplicate bandwidth. For example, the field on the duplicate bandwidth may be included in a PHY preamble and/or a scrambler seed, for example, to assist a responding STA to understand the duplicate bandwidth, which may be different from a reception bandwidth. For example, this duplicate bandwidth field may be useful, for example, to allow a STA to respond to an RTS, e.g., without information of the actual duplicate bandwidth.

For example, a scrambler seed design may be configured to utilize a scrambler seed design following a scrambled seed design in the sub-7 GHz band for a non-HT duplicate PPDU.

In some demonstrative aspects, the duplicate transmission may include only a PHY preamble, e.g., even without a MAC payload.

In some demonstrative aspects, device 102 and/or device 140 may be configured to transmit an mmWave operation element to define a Basic Service Set (BSS) configuration, e.g., as described below.

For example, controller 124 may be configured to control, trigger, cause, and/or instruct the wireless communication device implemented by device 102 to transmit the mmWave operation element to define the BSS configuration.

For example, controller 154 may be configured to control, trigger, cause, and/or instruct the wireless communication device implemented by device 140 to transmit the mmWave operation element to define the BSS configuration.

In some demonstrative aspects, the mmWave operation element may include a primary channel field, a channel width field, and/or a Channel Center Frequency (CCF) field, e.g., as described below.

In some demonstrative aspects, the primary channel field may be configured to define a channel number of a primary channel of the BSS having a primary channel BW equal to the minimal mmWave channel BW, e.g., as described below.

In some demonstrative aspects, the channel width field may be configured to define a channel width of the BSS, for example, as an integer multiple of the minimal mmWave channel BW, e.g., as described below.

In some demonstrative aspects, the CCF field may be configured to define a CCF of the channel width of the BSS, e.g., as described below.

In some demonstrative aspects, a Wi-Fi 8 60 GHz operation element may be defined, for example, for a BSS configuration, e.g., as described below.

In some demonstrative aspects, a primary channel field in the Wi-Fi 8 60 GHz operation element may be configured to indicate a channel number of the primary channel, for example, based on the minimum channel width in the 60 GHz band.

In some demonstrative aspects, the Wi-Fi 8 60 GHz operation element may be configured to indicate a channel width according to a predefined encoding scheme, e.g., as follows:
0: minimum channel width
1:2 times of minimum channel width.
2:4 times of minimum channel width
3:8 times of minimum channel width.
4:16 times of minimum channel width

In other aspects, any other additional or alternative encoding scheme may be used for indicating the channel width.

In some demonstrative aspects, the Wi-Fi 8 60 GHz operation element may be configured to indicate a CCF corresponding to the indicated channel width of the BSS, for example, according the predefined encoding scheme defined above.

In other aspects, any other additional or alternative encoding scheme may be used for indicating the CCF.

In some demonstrative aspects, device 102 and/or device 140 may be configured to disallow a co-hosted BSSID set in the 60 GHz band.

In some demonstrative aspects, an operating mode indication and/or format in A-control for communication over the mmWave band may be defined, for example, based on an operating mode indication and/or a format in A-control for communication over the sub-10 GHz band.

For example, the operating mode indication and/or the format in A-control in the sub-7 GHz band may be reused for the 60 GHz band, for example, by mapping a channel width of the sub-10 GHz band to a channel width of the mmWave band.

For example, the channel width of 20 MHz of the sub-10 GHz channelization scheme may be mapped to a minimum channel width of the mmWave channelization scheme.

For example, the channel width of 40 MHz of the sub-10 GHz channelization scheme may be mapped to a 2×-minimum channel width of the mmWave channelization scheme.

For example, the channel width of 80 MHz of the sub-10 GHz channelization scheme may be mapped to a 4×-minimum channel width of the mmWave channelization scheme.

For example, the channel width of 160 MHz of the sub-10 GHz channelization scheme may be mapped to an 8×-minimum channel width of the mmWave channelization scheme.

For example, the channel width of 320 MHz of the sub-10 GHz channelization scheme may be mapped to a 16×-minimum channel width of the mmWave channelization scheme.

In some demonstrative aspects, an operating mode notification indication and/or format for communication over the mmWave band may be defined, for example, based on an operating mode notification indication and/or format for communication over the sub-10 GHz band.

For example, the operating mode notification indication and/or the format in the sub-7 GHz band may be reused for the 60 GHz band, for example, by mapping a channel width of the sub-10 GHz band to a channel width of the mmWave band.

For example, the channel width of 20 MHz of the sub-10 GHz channelization scheme may be mapped to a minimum channel width of the mmWave channelization scheme.

For example, the channel width of 40 MHz of the sub-10 GHz channelization scheme may be mapped to a 2×-minimum channel width of the mmWave channelization scheme.

For example, the channel width of 80 MHz of the sub-10 GHz channelization scheme may be mapped to a 4×-minimum channel width of the mmWave channelization scheme.

For example, the channel width of 160 MHz of the sub-10 GHz channelization scheme may be mapped to an 8×-minimum channel width of the mmWave channelization scheme.

For example, the channel width of 320 MHz of the sub-10 GHz channelization scheme may be mapped to a 16×-minimum channel width of the mmWave channelization scheme.

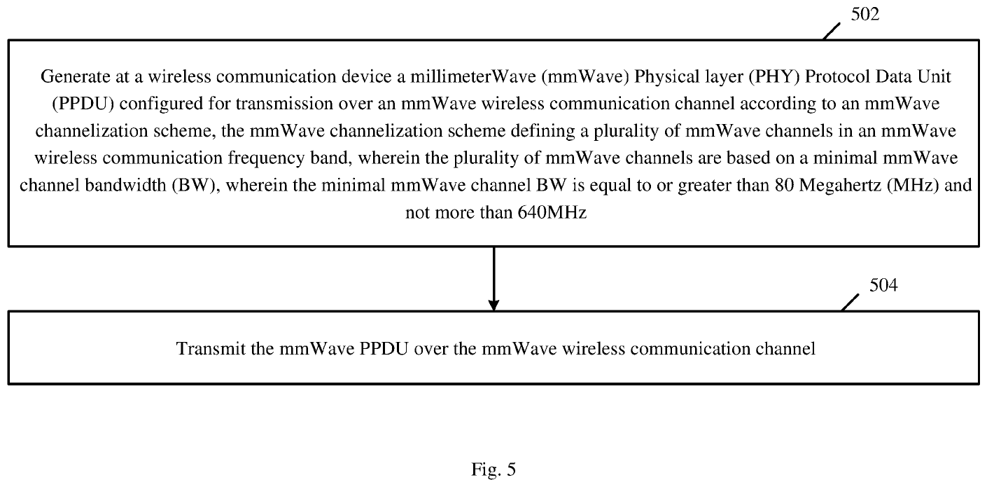

Reference is made to FIG. 5, which schematically illustrates a method of communicating an mmWave PPDU according to an mmWave channelization scheme, in accordance with some demonstrative aspects. For example, one or more of the operations of the method of FIG. 5 may be performed by one or more elements of a system, e.g., system 100 (FIG. 1), for example, one or more wireless devices, e.g., device 102 (FIG. 1), and/or device 140 (FIG. 1), an MLD, e.g., MLD 131 (FIG. 1) and/or MLD 151 (FIG. 1), a controller, e.g., controller 124 (FIG. 1) and/or controller 154 (FIG. 1), a radio, e.g., radio 114 (FIG. 1) and/or radio 144 (FIG. 1), and/or a message processor, e.g., message processor 128 (FIG. 1) and/or message processor 158 (FIG. 1).

As indicated at block 502, the method may include generating at a wireless communication device a mmWave PPDU configured for transmission over an mmWave wireless communication channel according to an mmWave channelization scheme, the mmWave channelization scheme defining a plurality of mmWave channels in an mmWave wireless communication frequency band, wherein the plurality of mmWave channels are based on a minimal mmWave channel BW, for example, wherein the minimal mmWave channel BW is equal to or greater than 80 MHz and not more than 640 MHz. For example, device 102 (FIG. 1) and/or device 140 (FIG. 1) may be configured to generate the mmWave PPDU configured for transmission over the mmWave wireless communication channel according to the mmWave channelization scheme, e.g., as described above.

As indicated at block 504, the method may include transmitting the mmWave PPDU over the mmWave wireless communication channel. For example, device 102 (FIG. 1) and/or device 140 (FIG. 1) may be configured to transmit the mmWave PPDU over the mmWave wireless communication channel, e.g., as described above.

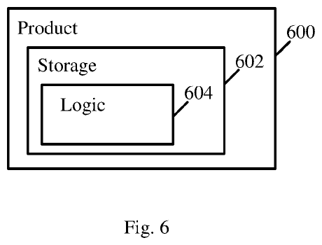

Reference is made to FIG. 6, which schematically illustrates a product of manufacture 600, in accordance with some demonstrative aspects. Product 600 may include one or more tangible computer-readable (“machine-readable”) non-transitory storage media 602, which may include computer-executable instructions, e.g., implemented by logic 604, operable to, when executed by at least one computer processor, enable the at least one computer processor to implement one or more operations at device 102 (FIG. 1), device 140 (FIG. 1), MLD 131 (FIG. 1), MLD 151 (FIG. 1), radio 114 (FIG. 1), radio 144 (FIG. 1), transmitter 118 (FIG. 1), transmitter 148 (FIG. 1), receiver 116 (FIG. 1), receiver 146 (FIG. 1), message processor 128 (FIG. 1), message processor 158 (FIG. 1), controller 124 (FIG. 1), and/or controller 154 (FIG. 1), to cause device 102 (FIG. 1), device 140 (FIG. 1), MLD 131 (FIG. 1), MLD 151 (FIG. 1), radio 114 (FIG. 1), radio 144 (FIG. 1), transmitter 118 (FIG. 1), transmitter 148 (FIG. 1), receiver 116 (FIG. 1), receiver 146 (FIG. 1), message processor 128 (FIG. 1), message processor 158 (FIG. 1), controller 124 (FIG. 1), and/or controller 154 (FIG. 1), to perform, trigger and/or implement one or more operations and/or functionalities, and/or to perform, trigger and/or implement one or more operations and/or functionalities described with reference to the FIGS. 1, 2, 3, 4, and/or 5, and/or one or more operations described herein. The phrases “non-transitory machine-readable medium” and “computer-readable non-transitory storage media” may be directed to include all machine and/or computer readable media, with the sole exception being a transitory propagating signal.

In some demonstrative aspects, product 600 and/or machine-readable storage media 602 may include one or more types of computer-readable storage media capable of storing data, including volatile memory, non-volatile memory, removable or non-removable memory, erasable or non-erasable memory, writeable or re-writeable memory, and the like. For example, machine-readable storage media 602 may include, RAM, DRAM, Double-Data-Rate DRAM (DDR-DRAM), SDRAM, static RAM (SRAM), ROM, programmable ROM (PROM), erasable programmable ROM (EPROM), electrically erasable programmable ROM (EEPROM), flash memory (e.g., NOR or NAND flash memory), content addressable memory (CAM), polymer memory, phase-change memory, ferroelectric memory, silicon-oxide-nitride-oxide-silicon (SONOS) memory, a disk, a hard drive, and the like. The computer-readable storage media may include any suitable media involved with downloading or transferring a computer program from a remote computer to a requesting computer carried by data signals embodied in a carrier wave or other propagation medium through a communication link, e.g., a modem, radio or network connection.

In some demonstrative aspects, logic 604 may include instructions, data, and/or code, which, if executed by a machine, may cause the machine to perform a method, process and/or operations as described herein. The machine may include, for example, any suitable processing platform, computing platform, computing device, processing device, computing system, processing system, computer, processor, or the like, and may be implemented using any suitable combination of hardware, software, firmware, and the like.

In some demonstrative aspects, logic 604 may include, or may be implemented as, software, a software module, an application, a program, a subroutine, instructions, an instruction set, computing code, words, values, symbols, and the like. The instructions may include any suitable type of code, such as source code, compiled code, interpreted code, executable code, static code, dynamic code, and the like. The instructions may be implemented according to a predefined computer language, manner or syntax, for instructing a processor to perform a certain function. The instructions may be implemented using any suitable high-level, low-level, object-oriented, visual, compiled and/or interpreted programming language, machine code, and the like.

### EXAMPLES

The following examples pertain to further aspects.

Example 1 includes an apparatus comprising logic and circuitry configured to cause a wireless communication device to generate a millimeterWave (mmWave) Physical layer (PHY) Protocol Data Unit (PPDU) configured for transmission over an mmWave wireless communication channel according to an mmWave channelization scheme, the mmWave channelization scheme defining a plurality of mm Wave channels in an mmWave wireless communication frequency band, wherein the plurality of mmWave channels are based on a minimal mmWave channel bandwidth (BW), wherein the minimal mmWave channel BW is equal to or greater than 80 Megahertz (MHz) and not more than 640 MHz; and transmit the mmWave PPDU over the mmWave wireless communication channel.

Example 2 includes the subject matter of Example 1, and optionally, wherein the plurality of mmWave channels comprises a plurality of nonoverlapping minimal-BW channels having the minimal mmWave channel BW.

Example 3 includes the subject matter of Example 2, and optionally, wherein the plurality of nonoverlapping minimal-BW channels comprises more than 20 nonoverlapping minimal-BW channels.

Example 4 includes the subject matter of any one of Examples 1-3, and optionally, wherein the plurality of mmWave channels comprises a plurality of wide channels, each wide channel having a wide channel BW which is at least double the minimal mmWave channel BW.

Example 5 includes the subject matter of Example 4, and optionally, wherein all wide channels having a same channel BW are nonoverlapping.

Example 6 includes the subject matter of Example 4, and optionally, wherein the plurality of wide channels comprises first and second partially overlapping wide channels having a same channel BW.

Example 7 includes the subject matter of any one of Examples 1-6, and optionally, wherein the plurality of mmWave channels comprises a plurality of nonoverlapping 2×-wide channels, each having a channel BW which is double the minimal mmWave channel BW, wherein a 2×-wide channel covers two minimal-BW channels having the minimal mmWave channel BW.

Example 8 includes the subject matter of any one of Examples 1-7, and optionally, wherein the plurality of mmWave channels comprises a plurality of nonoverlapping 4×-wide channels, each having a channel BW which is 4 times the minimal mmWave channel BW, wherein a 4×-wide channel covers 4 minimal BW channels having the minimal mmWave channel BW.

Example 9 includes the subject matter of any one of Examples 1-8, and optionally, wherein the plurality of mmWave channels comprises a plurality of nonoverlapping 8×-wide channels, each having a channel BW which is 8 times the minimal mmWave channel BW, wherein an 8×-wide channel covers 8 minimal BW channels having the minimal mmWave channel BW.

Example 10 includes the subject matter of any one of Examples 1-9, and optionally, wherein the plurality of mmWave channels comprises a plurality of nonoverlapping 16×-wide channels, each having a channel BW which is 16 times the minimal mmWave channel BW, wherein an 16×-wide channel covers 16 minimal BW channels having the minimal mmWave channel BW.

Example 11 includes the subject matter of any one of Examples 1-10, and optionally, wherein the mmWave channelization scheme comprises a definition of a primary channel BW equal to the minimal mmWave channel BW, and one or more secondary channel BWs, wherein the one or more secondary channel BWs comprise one or more of a secondary channel BW equal to double the minimal mmWave channel BW, a secondary channel BW equal to 4 times the minimal mmWave channel BW, or a secondary channel BW equal to 8 times the minimal mmWave channel BW.

Example 12 includes the subject matter of any one of Examples 1-11, and optionally, wherein the apparatus is configured to disable the wireless communication device to transmit a non High Throughput (HT) (non-HT) duplicate PPDU transmission over the mmWave wireless communication channel.

Example 13 includes the subject matter of any one of Examples 1-12, and optionally, wherein the apparatus is configured to disable the wireless communication device to transmit over the mmWave wireless communication channel legacy-format PPDUs of at least one disabled legacy PPDU format, the at least one disabled legacy PPDU format comprising at least one of a High Throughput (HT) PPDU format, a Very High Throughput (VHT) PPDU format, a High Efficiency (HE) PPDU format, or an Extremely High Throughput (EHT) PPDU format.

Example 14 includes the subject matter of Example 13, and optionally, wherein the apparatus is configured to disable the wireless communication device to include in the mmWave PPDU at least one of a capabilities element corresponding to the disabled legacy PPDU format, or an operation element corresponding to the disabled legacy PPDU format.

Example 15 includes the subject matter of Example 13 or 14, and optionally, wherein the apparatus is configured to cause the wireless communication device to include a mmWave band capabilities element in a frame transmitted by the wireless communication device, the mmWave band capabilities element configured to indicate one or more reused capabilities of the disabled legacy PPDU format.

Example 16 includes the subject matter of any one of Examples 13-15, and optionally, wherein the apparatus is configured to cause the wireless communication device to include a mmWave band operation element in a frame transmitted by the wireless communication device, the mmWave band operation element configured to indicate one or more reused operation information elements of the disabled legacy PPDU format.

Example 17 includes the subject matter of any one of Examples 1-16, and optionally, wherein the apparatus is configured to allow the wireless communication device to transmit over the mmWave wireless communication channel legacy-format PPDUs of only one allowed legacy PPDU format of a High Throughput (HT) PPDU format, a Very High Throughput (VHT) PPDU format, a High Efficiency (HE) PPDU format, or an Extremely High Throughput (EHT) PPDU format.

Example 18 includes the subject matter of Example 17, and optionally, wherein the apparatus is configured to allow the wireless communication device to transmit over the mmWave wireless communication channel a PPDU duplicate transmission according to the allowed legacy PPDU format.

Example 19 includes the subject matter of Example 18, and optionally, wherein the apparatus is configured to cause the wireless communication device to transmit a control frame in the PPDU duplicate transmission according to the allowed legacy PPDU format.

Example 20 includes the subject matter of any one of Examples 1-19, and optionally, wherein the apparatus is configured to allow the wireless communication device to transmit over the mmWave wireless communication channel upclocked PPDUs of an allowed legacy PPDU format, the allowed legacy PPDU format comprising a non High Throughput (HT) (non-HT) PPDU format, an HT PPDU format, a Very High Throughput (VHT) PPDU format, a High Efficiency (HE) PPDU format, or an Extremely High Throughput (EHT) PPDU format, wherein the upclocked PPDUs of the allowed legacy PPDU format comprise an upclocking of a legacy PPDU of the allowed legacy PPDU format based on a ratio between the minimal mmWave channel BW and 20 MHz.

Example 21 includes the subject matter of any one of Examples 1-20, and optionally, wherein the apparatus is configured to cause the wireless communication device to transmit an mmWave duplicate PPDU transmission over a wide channel covering a plurality of minimal-BW channels having the minimal mmWave channel BW, wherein the mmWave duplicate PPDU transmission comprises a duplicated transmission, which is duplicated over the plurality of minimal-BW channels.

Example 22 includes the subject matter of Example 21, and optionally, wherein the duplicated transmission comprises an indication of the wide channel.

Example 23 includes the subject matter of any one of Examples 1-22, and optionally, wherein the apparatus is configured to cause the wireless communication device to transmit an mmWave operation element to define a Basic Service Set (BSS) configuration, the mmWave operation element comprising a primary channel field, a channel width field, and a Channel Center Frequency (CCF) field, wherein the primary channel field is configured to define a channel number of a primary channel of the BSS having a primary channel BW equal to the minimal mm Wave channel BW, the channel width field is configured to define a channel width of the BSS as an integer multiple of the minimal mm Wave channel BW, the CCF field is configured to define a CCF of the channel width of the BSS.

Example 24 includes the subject matter of any one of Examples 1-23, and optionally, wherein channel BWs of the plurality of mmWave channels are integer multiples of the minimal mmWave channel BW.

Example 25 includes the subject matter of any one of Examples 1-24, and optionally, wherein the minimal mmWave channel BW is an integer multiple of 80 MHz.

Example 26 includes the subject matter of any one of Examples 1-25, and optionally, wherein the minimal mmWave channel BW is 80 MHz.

Example 27 includes the subject matter of any one of Examples 1-26, and optionally, wherein the minimal mmWave channel BW is 160 MHz.

Example 28 includes the subject matter of any one of Examples 1-27, and optionally, wherein the apparatus is configured to cause the wireless communication device to transmit the PPDU over the mmWave wireless communication channel by reusing one or more elements of a sub 10 Gigahertz (GHz) (sub-10 GHz) PHY of the wireless communication device.

Example 29 includes the subject matter of any one of Examples 1-28, and optionally, wherein the mmWave channelization scheme comprises a channel structure compatible with a channel structure of a sub 10 Gigahertz (GHz) (sub-10 GHz) channelization scheme.

Example 30 includes the subject matter of any one of Examples 1-29, and optionally, wherein the mmWave wireless communication frequency band comprises a 60 GHz frequency band.

Example 31 includes the subject matter of claim 30, and optionally, wherein the mmWave wireless communication frequency band comprises a 14 Gigahertz (GHz) frequency bandwidth.

Example 32 includes the subject matter of any one of Examples 1-31, and optionally, comprising at least one radio to transmit the mmWave PPDU.

Example 33 includes the subject matter of Example 32, and optionally, comprising one or more antennas connected to the radio, and a processor to execute instructions of an operating system of the wireless communication device.

Example 34 comprises a wireless communication device comprising the apparatus of any of Examples 1-33.

Example 35 comprises an apparatus comprising means for executing any of the described operations of any of Examples 1-33.

Example 36 comprises a product comprising one or more tangible computer-readable non-transitory storage media comprising computer-executable instructions operable to, when executed by at least one processor, enable the at least one processor to cause a wireless communication device to perform any of the described operations of any of Examples 1-33.

Example 37 comprises an apparatus comprising: a memory interface; and processing circuitry configured to: perform any of the described operations of any of Examples 1-33.

Example 38 comprises a method comprising any of the described operations of any of Examples 1-33.

Functions, operations, components and/or features described herein with reference to one or more aspects, may be combined with, or may be utilized in combination with, one or more other functions, operations, components and/or features described herein with reference to one or more other aspects, or vice versa.

While certain features have been illustrated and described herein, many modifications, substitutions, changes, and equivalents may occur to those skilled in the art. It is, therefore, to be understood that the appended claims are intended to cover all such modifications and changes as fall within the true spirit of the disclosure.

1-25. (canceled)

26. An apparatus comprising logic and circuitry configured to cause a wireless communication device to:
generate a millimeterWave (mmWave) Physical layer (PHY) Protocol Data Unit (PPDU) configured for transmission over an mmWave wireless communication channel according to an mmWave channelization scheme, the mmWave channelization scheme defining a plurality of mmWave channels in an mmWave wireless communication frequency band, wherein the plurality of mmWave channels are based on a minimal mmWave channel bandwidth (BW), wherein the minimal mmWave channel BW is equal to or greater than 80 Megahertz (MHz) and not more than 640 MHz; and
transmit the mmWave PPDU over the mmWave wireless communication channel.

27. The apparatus of claim 26, wherein the plurality of mmWave channels comprises a plurality of nonoverlapping minimal-BW channels having the minimal mmWave channel BW.

28. The apparatus of claim 27, wherein the plurality of nonoverlapping minimal-BW channels comprises more than 20 nonoverlapping minimal-BW channels.

29. The apparatus of claim 26, wherein the plurality of mmWave channels comprises a plurality of wide channels, each wide channel having a wide channel BW which is at least double the minimal mmWave channel BW.

30. The apparatus of claim 26, wherein the plurality of mmWave channels comprises a plurality of nonoverlapping 2×-wide channels, each having a channel BW which is double the minimal mmWave channel BW, wherein a 2×-wide channel covers two minimal-BW channels having the minimal mmWave channel BW.

31. The apparatus of claim 26, wherein the plurality of mmWave channels comprises a plurality of nonoverlapping 4×-wide channels, each having a channel BW which is 4 times the minimal mmWave channel BW, wherein a 4×-wide channel covers 4 minimal BW channels having the minimal mmWave channel BW.

32. The apparatus of claim 26, wherein the plurality of mmWave channels comprises a plurality of nonoverlapping 8×-wide channels, each having a channel BW which is 8 times the minimal mmWave channel BW, wherein an 8×-wide channel covers 8 minimal BW channels having the minimal mmWave channel BW.

33. The apparatus of claim 26, wherein the plurality of mmWave channels comprises a plurality of nonoverlapping 16×-wide channels, each having a channel BW which is 16 times the minimal mmWave channel BW, wherein an 16×-wide channel covers 16 minimal BW channels having the minimal mmWave channel BW.

34. The apparatus of claim 26, wherein the mmWave channelization scheme comprises a definition of a primary channel BW equal to the minimal mmWave channel BW, and one or more secondary channel BWs, wherein the one or more secondary channel BWs comprise one or more of a secondary channel BW equal to double the minimal mmWave channel BW, a secondary channel BW equal to 4 times the minimal mmWave channel BW, or a secondary channel BW equal to 8 times the minimal mmWave channel BW.

35. The apparatus of claim 26 configured to disable the wireless communication device to transmit a non High Throughput (HT) (non-HT) duplicate PPDU transmission over the mmWave wireless communication channel.

36. The apparatus of claim 26 configured to disable the wireless communication device to transmit over the mmWave wireless communication channel legacy-format PPDUs of at least one disabled legacy PPDU format, the at least one disabled legacy PPDU format comprising at least one of a High Throughput (HT) PPDU format, a Very High Throughput (VHT) PPDU format, a High Efficiency (HE) PPDU format, or an Extremely High Throughput (EHT) PPDU format.

37. The apparatus of claim 36 configured to cause the wireless communication device to include an mmWave band operation element in a frame transmitted by the wireless communication device, the mmWave band operation element configured to indicate one or more reused operation information elements of the disabled legacy PPDU format.

38. The apparatus of claim 26 configured to allow the wireless communication device to transmit over the mmWave wireless communication channel upclocked PPDUs of an allowed legacy PPDU format, the allowed legacy PPDU format comprising a non High Throughput (HT) (non-HT) PPDU format, an HT PPDU format, a Very High Throughput (VHT) PPDU format, a High Efficiency (HE) PPDU format, or an Extremely High Throughput (EHT) PPDU format, wherein the upclocked PPDUs of the allowed legacy PPDU format comprise an upclocking of a legacy PPDU of the allowed legacy PPDU format based on a ratio between the minimal mmWave channel BW and 20 MHz.

39. The apparatus of claim 26 configured to cause the wireless communication device to transmit an mmWave duplicate PPDU transmission over a wide channel covering a plurality of minimal-BW channels having the minimal mmWave channel BW, wherein the mmWave duplicate PPDU transmission comprises a duplicated transmission, which is duplicated over the plurality of minimal-BW channels.

40. The apparatus of claim 26 configured to cause the wireless communication device to transmit an mmWave operation element to define a Basic Service Set (BSS) configuration, the mmWave operation element comprising a primary channel field, a channel width field, and a Channel Center Frequency (CCF) field, wherein the primary channel field is configured to define a channel number of a primary channel of the BSS having a primary channel BW equal to the minimal mmWave channel BW, the channel width field is configured to define a channel width of the BSS as an integer multiple of the minimal mmWave channel BW, the CCF field is configured to define a CCF of the channel width of the BSS.

41. The apparatus of claim 26, wherein the minimal mmWave channel BW is an integer multiple of 80 MHz.

42. The apparatus of claim 26 configured to cause the wireless communication device to transmit the PPDU over the mmWave wireless communication channel by reusing one or more elements of a sub 10 Gigahertz (GHz) (sub-10 GHz) PHY of the wireless communication device.

43. The apparatus of claim 26 comprising a radio to transmit the mmWave PPDU, one or more antennas connected to the radio, and a processor to execute instructions of an operating system of the wireless communication device.

44. A product comprising one or more tangible computer-readable non-transitory storage media comprising computer-executable instructions operable to, when executed by at least one processor, enable the at least one processor to cause a wireless communication device to:
generate a millimeterWave (mmWave) Physical layer (PHY) Protocol Data Unit (PPDU) configured for transmission over an mmWave wireless communication channel according to an mmWave channelization scheme, the mmWave channelization scheme defining a plurality of mmWave channels in an mmWave wireless communication frequency band, wherein the plurality of mmWave channels are based on a minimal mmWave channel bandwidth (BW), wherein the minimal mmWave channel BW is equal to or greater than 80 Megahertz (MHz) and not more than 640 MHz; and
transmit the mm Wave PPDU over the mmWave wireless communication channel.

45. The product of claim 44, wherein the plurality of mmWave channels comprises a plurality of nonoverlapping minimal-BW channels having the minimal mm Wave channel BW.
